(19) United States
(12) Patent Application Publication
(10) Pub. No.: US 2012/0200158 A1
(43) Pub. Date: Aug. 9, 2012

(54) WIRELESS POWER TRANSMISSION SYSTEM AND WIRELESS POWER TRANSMISSION APPARATUS

(75) Inventor: Ken Takei, Kawasaki (JP)

(73) Assignee: Hitachi, Ltd., Chiyoda-ku, Tokyo (JP)

(21) Appl. No.: 13/500,709

(22) PCT Filed: Oct. 8, 2009
(86) PCT No.: PCT/JP2009/067563

§ 371 Date: Apr. 6, 2012

(51) Int. Cl. H02J 17/00

(52) U.S. Cl. 307/31

(57) ABSTRACT

A wireless power transmission system is a system essentially includes a small number of transmitters and a large number of receivers having unique IDs, in which the transmitter collectively controls variable reactance inside the transmitter and the receiver by using the same ID so as to perform one-to-multiple power transmission. Specifically, aiming to achieve the one-to-multiple wireless power transmission system capable of adaptively controlling a power transmission efficiency, the transmitter registers a unique ID transmitted by the receiver, and requests the receiver to report on power reception state for each ID, thereby collectively controlling variable reactance inside the transmitter and the receiver according to the content of the report so that the power transmission efficiency inside the system is dynamically optimized.

### TECHNICAL FIELD

The present invention relates to a system and an apparatus for wirelessly transmitting power by using electromagnetic waves, and a transmission method thereof, and in particular, it relates to a wireless power transmission system, a wireless power transmission apparatus, and a power transmission method suitable for power transmission in the Fresnel region where an electrostatic field and an induction field play a major role for energy interactions of an electromagnetic field as compared with a radiated field, and especially, it relates to an ID-controlled one-to-multiple wireless power transmission system for selectively transmitting power to a specified receiver out of a plurality of receivers by using an ID, and an ID-controlled one-to-multiple wireless power transmission apparatus, and further, it relates to a wireless supplied electric power charging system.

### BACKGROUND ART

Conventionally, as a system for wirelessly transmitting power, there has been a passive RFID in which, by using a radiated field component of an electromagnetic wave emitted from a transmitter, a receiver catches the electromagnetic field, converts the same into an alternating current, and rectifies the alternating current to obtain electricity that can be used as a electrical source (for example, see Non-patent Document 1).

### PRIOR ART DOCUMENT

### Non-Patent Document

Non-Patent Document 1: Klaus Finkenzeller, RFID Handbook, Second Edition, (translated by SOFEL Research and Development, published by The Nikkan Kogyo Shimbun Ltd., May 2004, pp. 43-45).

### DISCLOSURE OF THE INVENTION

### Problems to be Solved by the Invention

With advancement in wireless technology, a large information amount can be carried on an electromagnetic wave and wirelessly transmitted. Accompanied with this progress, information equipment has overcome the deterioration of conveniences due to wiring connection by eliminating as many wires as possible as transmission/reception medium of information. However, the main stream of the supply of the power for enabling information equipment to operate is still wires, and many of information equipment is not yet in the circumstances where practically no restrictions are imposed on the installation and the movement free from wiring connection.

Wireless power transmission has already been put into practice in part when the power to be transmitted is small. Atypical example of that is called “passive RFID”, in which a receiver catches an electromagnetic field by using a radiated field component of an electromagnetic wave emitted from a transmitter and converts the same to an alternating current, and rectifies the alternating current to obtain power that can be used as a power source. This technology is described in Non-patent Document 1. The power used by the receiver of RFID is approximately several microwatts at present, and is incomparably small as compared with several to several tens of watts order which are the power required for operating general consumer equipment.

An energy distribution of the electromagnetic field emitted from the transmitter into a space essentially consists of three fields of the electrostatic field, the induction field, and the radiated field according to an attenuation manner associated with a distance from the radiation point, and is attenuated by the cube of the distance, the square of the distance, and the first power of the distance, respectively. An energy amount of each field in the immediate vicinity of the emission point of the power is reduced by several orders of magnitude in the order of the electrostatic field, the induction field, and the radiated field. The electromagnetic field of the wireless power transmission used by RFID of the conventional technology is mainly the radiated field or the induction field, and the power transmission of several to several tens of watts order enabling the consumer equipment to operate is not yet realized. When the transmitter and the receiver are physically contacted with each other, though not electrically contacted, or extremely adjacent to each other, the power transmission of several watts order is made possible by the electrostatic field. However, practically, this does not make the power remotely supplied, and is not sufficient to improve the level of convenience with respect to the installation and movement of the information equipment by the wireless transmission of the power. For example, when consideration is given to the real usage pattern of the information equipment including imaging apparatuses at home or within offices, the power transmission that replaces a remotely wired power source line having a distance of about one meter is required.

To transmit the power at such a distance, it is effective to use a region high in the remote transmission ability by the electromagnetic field and to take advantage of every one of the three components of the electrostatic field, the induction field, and the radiated field possessed by the electromagnetic field. In such circumstances, since the transmitting part of the power and the receiving part of the power are mutually coupled through reactive energy formed by the electrostatic field and the induction field and positionally localized, power transmission efficiency is greatly influenced electric circuit-wise by the internal impedance changes of the transmitting part and the receiving part and the mutual impedance change upon considering the transmitting part and the receiving part as a 2-terminal pair electric circuit network. Here, the “reactive energy” means energy formed based on the action of a reactance component (an imaginary part of the impedance) that constitutes an impedance of the transmission path when a space existing between the transmitting part and the receiving part, a transmitter antenna, and a receiver antenna are viewed as a power transmission path.

In other words, to maintain the power transmission efficiency good from the transmitting part to the receiving part, it is effective to make the internal impedance and the mutual impedance changed dynamically according to the change of the mutual positional relationship between the transmitting part and the receiving part and the change of ambient environment surrounding these parts.

In the actual wireless power transmission system, a configuration having a plurality of receiving parts for one transmitting part is preferable in view of the level of convenience and also in view of reducing the number of equipment that forms the power transmission system.

The medium that makes the wireless transmission possible is realistically the electromagnetic wave, and its frequency resources exist in finite amounts. Consequently, to realize coexistence with other communication systems and wireless applied systems including power transmission, it is preferable to perform power transmission to a plurality of receiving parts by means of one frequency or frequencies as small in number as possible.

When such one-to-multiple power transmission using one frequency is performed using the reactive energy that is positionally localized, since the reactive energy has locality, one transmitter and a plurality of receivers form a mutually intimate coupled state by the reactive energy. In other words, the internal impedance change of one receiver influences not only the transmitter but also the other receivers. This influence is presently and concurrently generated if the speed of light is delayed due to locality of reactive energy. In the power transmission not using the reactive energy, the transmitter and the plurality of receivers are not in an electrically intimate coupled state, and there is no need to think technologically that the internal impedance change of one receiver exerts influence over the transmitter and the other receivers. In such one-to-multiple power transmission through the reactive energy, a purpose of increasing the power transmission efficiency maximum as a whole system including all transmitters and receivers is not necessarily achieved only by maximizing the power transmission efficiency associated with a set of transmitter and receiver. This is because a combination of the internal impedance of the receiver and the internal impedance of the transmitter that makes the power transmission maximum between a certain set of transmitter and receiver does not necessary match the internal impedance of the transmitter in a combination of internal impedances in such a manner that the power transmission efficiency between the transmitter and other receiver is made maximum. In other words, in the power transmission using one-to-multiple identical frequency, the power transmission efficiency in the combination of the individual transmitters and receivers is not necessarily maximum in a state in which the maximum power transmission efficiency is achieved as the whole power transmission system. Consequently, to make the power transmission efficiency of the whole system maximum, the transmitter directly and intimately coupled with each receiver by the localized reactive energy needs to grasp information on the internal impedances of all the receivers and power transmission amounts of the individual receivers and control the internal impedance of the transmitter and the internal impedance of each receiver so that the power transmission efficiency of the whole system becomes maximum.

A preferred aim of the present invention is to provide means for transmitting the power from the transmitting part to a plurality of receiving parts with high efficiency in adapting to the change of the mutual positional relationship between the transmitting part and the receiving part and the change of the ambient environment surrounding the transmitting part and the receiving part with one frequency or frequencies as small in number as possible by using all fields of the electrostatic field, the induction field, and the radiated field possessed by the electromagnetic field which are mutually coupled with each other through the reactive energy in which the transmitting part and the receiving part of the power are positionally localized.

### Means for Solving the Problems

An example of the representative aspect of the present invention will be described as follows.

That is, the wireless power transmission system of the present invention is a wireless power transmission system including one transmitter and a plurality of receivers. The transmitter is provided with an antenna, a variable reactance circuit of transmitting part, a control circuit of transmitting part, a modulator of transmitting part, and a carrier wave generation circuit. Each of the receivers is provided with an antenna, a variable reactance circuit of receiving part, a demodulator of receiving part, a control circuit of receiving part, a rectifying circuit, and an ID memory device, and each of the receivers is assigned with a unique ID to each receiver. The transmitter controls the variable reactance circuit of transmitting part by the control circuit of transmitting part so as to transmit the ID and a control command. Each of the receivers receives the ID and the control command transmitted from the transmitter, and the receiver having a received ID matching an ID unique to the receiver stored in the ID memory device controls the variable reactance circuit of receiving part by the control circuit of receiving part.

Further, the wireless power transmission apparatus of the present invention includes one transmitter and a plurality of receivers, the transmitter being provided with an antenna, a variable reactance circuit of transmitting part, a control circuit of transmitting part, a modulator of transmitting part, and a carrier wave generation circuit, each of the receivers being provided with an antenna, a variable reactance circuit of receiving part, a demodulator of receiving part, a control circuit of receiving part, a rectifying circuit, and an ID memory device, and each of the receivers is assigned with a unique ID to each receiver. The transmitter controls the variable reactance circuit of transmitting part by the control circuit of transmitting part so as to transmit the ID and a control command. Each of the receivers receives the ID and the control command transmitted from the transmitter, and the receiver whose received ID matches an ID unique to the receiver stored in the ID memory device is a wireless power transmission apparatus used for the receiver of the wireless power transmission system that controls the variable reactance circuit of receiving part by the control circuit of receiving part, and is further provided with a modulation circuit together with the antenna, the variable reactance circuit of receiving part, the demodulator of receiving part, the control circuit of receiving part, the rectifying circuit, and the ID memory device. The modulation circuit is composed of a semiconductor switch, and the communication toward the transmitter is performed by a back-scattering method.

### Effects of the Invention

According to the present invention, the system can be achieved in which one transmitter performs highly efficient power transmission simultaneously to a plurality of receivers using one frequency.

### BRIEF DESCRIPTIONS OF THE DRAWINGS

FIG. 1 is a block diagram of an ID-controlled one-to-multiple wireless power transmission system of the present invention;

FIG. 2 is a power transmission control flow chart of the receiver constituting the ID-controlled one-to-multiple wireless power transmission system of the present invention;

FIG. 3 is a power transmission control flow chart of the receiver constituting the ID-controlled one-to-multiple wireless power transmission system of the present invention;

FIG. 4 is a flowchart of controlling the transmitter for describing a control time sequence of the ID-controlled one-to-multiple wireless power transmission system of the present invention;

FIG. 5 is a flow chart of controlling the receiver for describing a control time sequence of the ID-controlled one-to-multiple wireless power transmission system of the present invention;

FIG. 6 is a block diagram of the ID-controlled one-to-multiple wireless power transmission system of the present invention;

FIG. 7 is a receiver state transition table for describing a control time sequence of the ID-controlled one-to-multiple wireless power transmission system of the present invention;

FIG. 8A is a frequency spectrum for each time slot of the ID-controlled one-to-multiple wireless power transmission system of the present invention, and is a view showing the case of RI and T1;

FIG. 8B is a frequency spectrum for each time slot of the ID-controlled one-to-multiple wireless power transmission system of the present invention, and is a view showing the case of R3 and T3;

FIG. 9 is a block diagram of the ID-controlled one-to-multiple wireless power transmission system having a plurality of transmitters of the present invention;

FIG. 10 is a block diagram of the ID-controlled one-to-multiple wireless power transmission system of the present invention;

FIG. 11A is a view showing a configuration example of the ID-controlled one-to-multiple wireless power transmission system of the present invention;

FIG. 11B is a view showing an equivalent circuit of the system configuration of 11A;

FIG. 12A is a view showing a configuration example of the ID-controlled one-to-multiple wireless power transmission system of the present invention;

FIG. 12B is an equivalent circuit of the ID-controlled one-to-multiple wireless power transmission system of the present invention;

FIG. 12C is a view showing an equivalent circuit of the system configuration of FIG. 12A;

FIG. 13 is a structure of an antenna constituting the ID-controlled one-to-multiple wireless power transmission system of the present invention;

FIG. 14 is a structure of an antenna constituting the ID-controlled one-to-multiple wireless power transmission system of the present invention;

FIG. 15 is a structure of an antenna constituting the ID-controlled one-to-multiple wireless power transmission system of the present invention;

FIG. 16 is a structure of an antenna constituting the ID-controlled one-to-multiple wireless power transmission system of the present invention;

FIG. 17 is mutual impedance characteristics of a transceiving antenna constituting the ID-controlled one-to-multiple wireless power transmission system of the present invention;

FIG. 18 is a view showing a configuration example of the ID-controlled one-to-multiple wireless power transmission system of the present invention;

FIG. 19 is a view showing a configuration example of the ID-controlled one-to-multiple wireless power transmission system of the present invention;

FIG. 20 is a view showing a configuration example of the ID-controlled one-to-multiple wireless power transmission system of the present invention; and

FIG. 21 is a block diagram of the ID-controlled one-to-multiple wireless power transmission system of the present invention.

### BEST MODE FOR CARRYING OUT THE INVENTION

To solve the above described problems, a transmitting part and a receiving part are provided with an antenna, a variable reactance element, a modulation circuit, and a demodulation circuit.

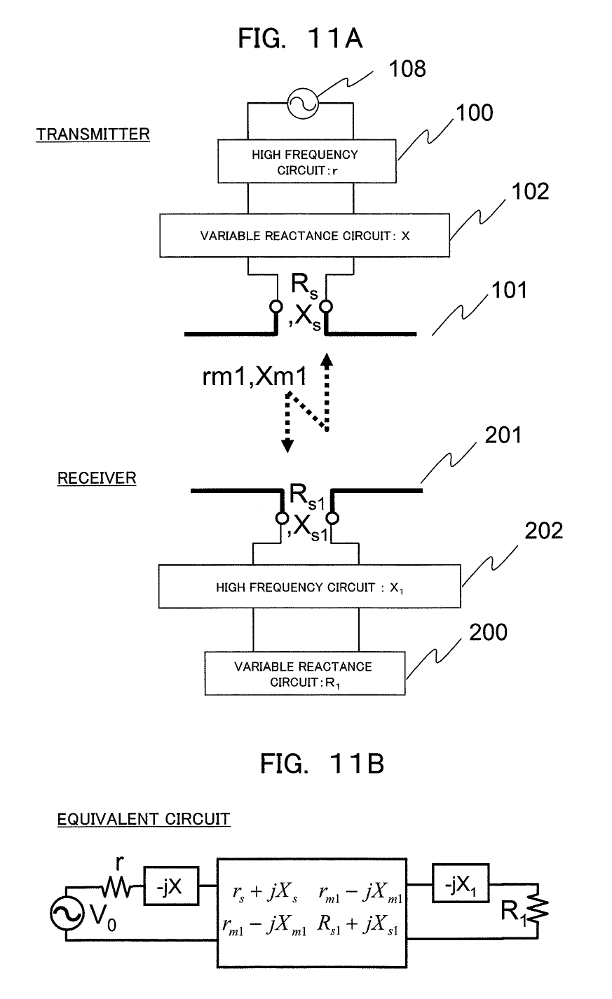

The receiving part has a unique ID. To explain about the principle of the invention, FIGS. 11A and 11B are employed. FIG. 11A is a view showing a configuration example of a wireless power transmission system constituted of the transmitter and the receiver.

FIG. 11B is a view showing an equivalent circuit of the system configuration thereof. The power transfer functions of the transmitter and the receiver i (i=1, 2) of FIG. 11A will be expressed by the following formula 1 provided that the characteristic impedances of the receiver and the transmitter are taken as Ri and r and internal impedances at antenna ends are taken as Rsi+jXsi and rs+jXs.

$$\frac{( {r}_{m i}^{2} + {X}_{m i}^{2} ) {R}_{i}}{\begin{matrix}{( {r}_{m i}^{2} - {X}_{m i}^{2} - ( r + {r}_{s} ) ( {R}_{i} + {R}_{s i} ) + ( X + {X}_{s} ) ( {X}_{i} + {X}_{si} ) )}^{2} + \\ {( {r}_{m i} {X}_{m i} - ( r + {r}_{s} ) ( X + {X}_{s} ) - ( {R}_{i} + {R}_{si} ) ( {X}_{i} + {X}_{si} ) )}^{2}\end{matrix}} \qquad [ Formula 1 ]$$

The value of Xi making the power transfer function of Formula 1 maximum becomes the following Formula 2 by making the partial differential on Xi of the Formula 1 to be zero.

$${X}_{i} + {X}_{si} = \frac{( {R}_{i} + {R}_{si} ) ( {r}_{m i} {X}_{m i} ) - ( X + {X}_{s} ) ( {r}_{m i}^{2} - {X}_{m i}^{2} )}{{( X + {X}_{s} )}^{2} + {( {R}_{i} + {R}_{si} )}^{2}} \qquad [ Formula 2 ]$$

Since the transmitter needs to supply power to a plurality of receivers, consistency between an antenna in the transmitter and a high frequency circuit of the transmitter is required to be maintained good. The control circuit of the transmitter monitors the power returned to the high frequency circuit of the transmitter from the antenna of the transmitter by the modulator, and dynamically adjusts the variable reactance circuit. On the other hand, the receiver i may adjust the variable reactance circuit to a value equivalent to the Formula 2 in adapting to the change of the mutual positional relationship between the transmitter and the receiver i and the change of the ambient environment surrounding the transmitter and the receiver i in X maintaining consistency good between the antenna of the transmitter and a high frequency circuit. The receiver i reports a reception state of the power to the transmitter together with its own ID (IDi) and a received power value to the transmitter by using a modulator. The reception state needs to include the information at least on 1) under adjustment of received power, 2) under reception of power, and 3) reception of desired power not possible. The information on “reception of desired power not possible” is issued when the received power of the receiver does not reach the desired value within a preset time.

The transmitter stores the ID and the received power state transmitted from the receiver, and when there exists a receiver that emits a signal of the “reception of desired power not possible”, the transmitter notifies the receiver under the adjustment of the received power that the power cannot be supplied, and requests the receiver to make a compulsory change of a variable reactance value j so that the reception of the power becomes practically impossible. When there still exists a receiver that emits the signal of the “reception of desired power not possible” even by this change, the transmitter instructs the receiver to be supplied with power from the other transmitter. Further, when power to be supplied by the transmitter exceeds an allowable value preset due to the increase of the power consumption by a receiver under reception of the power and the increase of the number of receivers, the transmitter transmits the information on the stop of the power supply to the receivers j in the order of the smallest received power out of the receivers under reception of power, and performs the compulsory change of the variable reactance value j so that the reception of power becomes practically impossible. The receiver to which power is not supplied or whose power supply is interrupted changes the value of the variable reactance again by avoiding the region of the variable reactance value compulsorily changed, and tries to get power supply from the other transmitter.

When there are many receivers available or a total required power amount of the receiver here is large, it is required to increase the number of the transmitters. In general, the high frequency power amplifier having a high output is not efficient because there is a practical limit to the maximum transmission power of the transmitter whose power transmission efficiency is good. In this case, each of the transmitters can use a different frequency. In that event, since a width of the variable reactance value by which a plurality of receivers can effectively receive the power becomes wider as a result, the control of the transmission efficiency of the power from the transmitter to the receivers becomes easy.

When the optimum power transfer function is obtained by using the value of Xi (i=1, 2) of Formula 2, the following Formula 3 can be established.

$$\frac{( {r}_{m i}^{2} + {X}_{m i}^{2} ) {R}_{i}}{{( {r}_{m i}^{2} - ( r + {r}_{s} ) ( {R}_{i} + {R}_{si} ) )}^{2} {( {X}_{m i}^{2} + ( r + {r}_{s} ) ( X + {X}_{s} ) )}^{2}} \qquad [ Formula 3 ]$$

As evident from Formula 3, when the real parts rs and Rsi of the self-impedances of the antenna of the transmitter and the antenna of the receiver are smaller than the real part rm of the mutual impedance between the transmitter and the receiver, the optimum value of the power transfer function can be taken greatly. To realize an antenna satisfying such a condition, a plurality of minute conductors are arranged according to a certain fixed rule, and the characteristics thereof are examined, and then, by updating a candidate for the arrangement satisfying the certain fixed rule at any time, an antenna structure satisfying the requested specifications of the power transmission system may be found. The update of the candidate can be executed, for example, by generating a combination of the plurality of minute conductors in a random manner under the certain fixed rule.

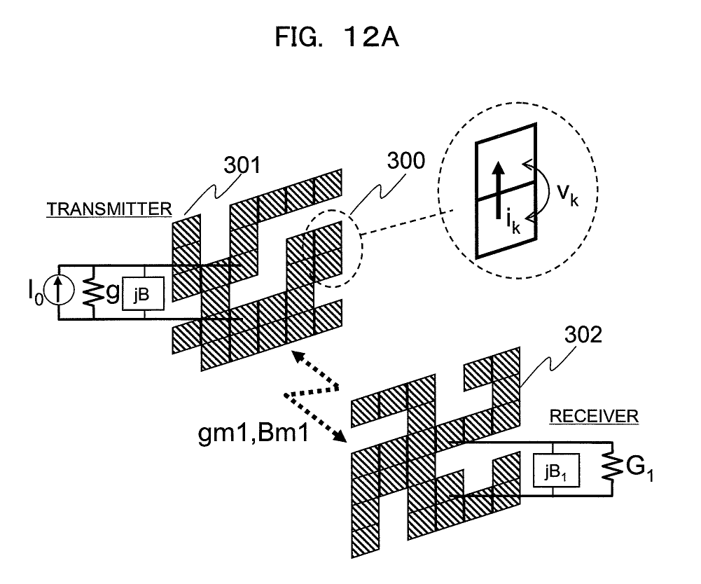

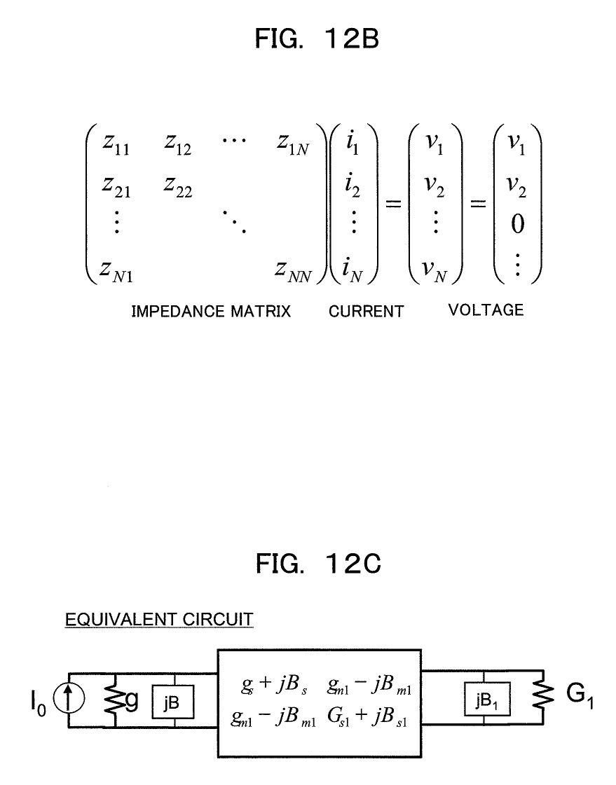

FIGS. 12A to 12C illustrate a method for calculating an operation of such an antenna. In the system configuration shown in FIG. 12A, a current ik is generated on a minute conductor 300 and a voltage vk is generated corresponding to the current ik. When a power supply point is not provided on the minute conductor, vk=0, and when the power supply point is provided, ik and vk are linearly coupled with each other by the impedance of the power supply point.

In the example of FIG. 12A, the power supply points of the transmitter antenna and the receiver antenna are presumed to be k=1, 2. The minute conductor has a mutual impedance zij (i≈j) between the self-impedance zii of its own and the other minute conductors. As a consequence, the structure of FIG. 12A and the voltage and the current associated with a plurality of minute conductors constituting the transmitter antenna and the receiver antenna can take one-to-one correspondence. The change of the antenna structure of FIG. 12A is revealed as a change of the shape of the impedance matrix (combination assembly of the self impedances of the plurality of minute conductors included in the matrix and the mutual impedances) of FIG. 12B. As evident from the shape of the matrix equation of FIG. 12B, if an admittance matrix that is the reverse of the impedance matrix is multiplied by both sides of the matrix equation from the left side, a new matrix equation can be obtained by a small part matrix of the admittance matrix of 2×2 with voltages v1 and v2 only taken as variables. An equivalent circuit corresponding to this matrix equation is shown in FIG. 12C. In contrast to the equivalent circuit of FIG. 11B, it is found that each of the relationships among Formulas 1 to 3 is established on the duality in FIGS. 12A to 12C.

Consequently, the condition under which the optimum value of the power transfer function is taken greatly is that the real parts gs and Gsi of the self-admittances of the power supply points of the transmitter antenna and the receiver antenna are smaller than the real part gm of the mutual admittance between the power supply point of the transmitter antenna and the power supply point of the receiver antenna in the case of the antenna pattern of FIG. 12A. Hence, it may be good if the structures of the transmitter antenna and the receiver antenna are found in which the self-admittance is small and the mutual admittance is great. Since the admittance matrix is the reverse of the impedance matrix that takes the self impedances and the mutual impedances of the plurality of minute conductors as elements, the straight line distance between the power supply point of the transmitter antenna and the power supply point of the receiver antenna is taken as small as possible so that the mutual admittance is made larger by using the relationship of mutual elements between the matrix and the inverse matrix with attention focused on the fact that the mutual impedances between the minute conductors are inversely proportional to the distance between the minute conductors. Thereby, a structure may be achieved in which a total sum of the straight line distances from the minute conductors existing on the same antenna (the transmitter antenna or the receiver antenna) seen from the power supply point is taken as large as possible to make the self-admittance small. Such structure can be realized in such a manner that the antennas of the transmitter and the receiver are formed by an assembly of the plurality of minute polygonal conductors on a flat surface, and the plurality of minute polygonal conductors are arranged such that the density becomes symmetrical to the axis of symmetry possessed by the flat surface, and each of power supply points provided on the minute polygonal conductors existing on the antenna of the transmitter and on the antenna of the receiver forms the shortest distance to connect the antenna of the transmitter and the antenna of the receiver, and is distributed apart from the axis of symmetry.

As evident from Formula 3, when the imaginary part absolute value of the mutual impedance of the antenna system formed by the antennas provided for the transmitter and the receiver is minimum, the maximum value is given by the power transfer function. This condition is nothing but that the imaginary part of the mutual impedance is zero, and is equivalent to the mutual impedance being in a resonance state. The mutual impedance changes by the mutual distance of the antennas provided for the transmitter and the receiver. The operation of the antenna is specified by the dimensional quantity normalized by the wavelength. The distance dependability of the mutual impedances of the antenna system is decided by the distance quantity normalized by the wavelength. As a consequence, the change of the mutual distance between the antennas having the mutual impedances can be offset by causing the frequency, which is the inverse of the wavelength, to be changed with an inverse proportional relationship. Thus, it is desirable that the transmission frequency of the transmitter is variable. Further, to emphasize the amount of change in the change of the transmission frequency of the transmitter with respect to the mutual impedance of the antenna system formed by the antennas provided for the transmitter and the receiver, it is effective to load a reactance element on a part of the antenna structure.

When the relative position between the transmitter and the receiver is changed, the mutual impedances of the antenna system formed by the antennas provided for the transmitter and the receiver are changed. To realize a highly efficient power transmission from the transmitter to the receiver followed by this change, it is effective that the variable reactance element is loaded on a part of the structure of the receiver antenna, and the variable reactance element is controlled to allow the transmitter to make a power receiving amount of the receiver maximum. To emphasize this effect, there is a method for loading the variable reactance element on a part of the structure of the transmitter antenna, and controlling the variable reactance element of a transceiver antenna in the same concept. In this case, the effect can be further emphasized by making the transmission frequency of the transmitter variable.

According to the present invention, in the wireless power transmission system capable of performing the transmission of the power having an efficiency higher than that of the wireless system which is the conventional technology and focused on a single field because of using all of the electrostatic field, the induction field, and the radiation filed generated in the space at the time of performing the power transmission by the electromagnetic wave, one transmitter can realize a highly efficient power transmission to the plurality of receivers simultaneously by using one frequency. This can create an effect of reducing the number of transmitters constituting the wireless power transmission system, and can operate the power transmission system in a state closer to the maximum power that can be transmitted by one transmitter. Thereby, the effect of operating a high frequency power amplifier provided for the transmitter at maximum efficiency can be created, and as a result, the power of the power transmission system itself can be saved.

Each embodiment of the present invention will be described in detail below with reference to the drawings.

### Embodiment 1

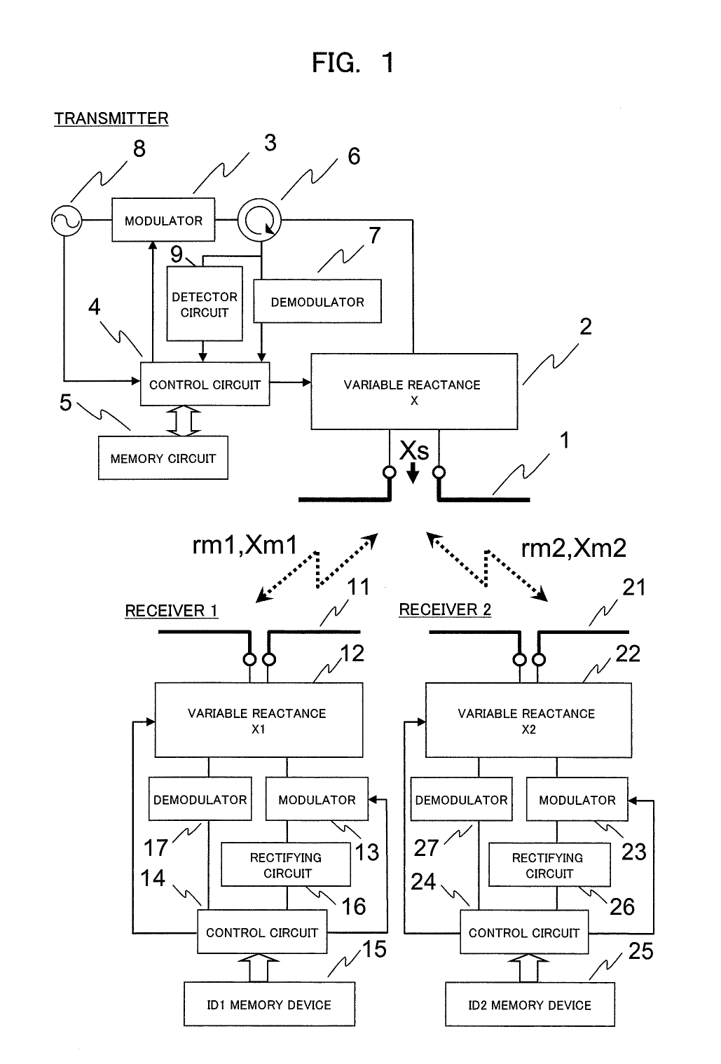

FIG. 1 is a view showing a configuration of an embodiment of an ID-controlled one-to-multiple wireless power transmission system of the present invention, which is constituted of one transmitter and two receivers, that is, a first receiver and a second receiver. The transmitter has a variable reactance circuit of transmitting part 2, which is coupled with a directional coupler 6, and is connected to a transmitting part antenna 1; the directional coupler 6 is connected with a carrier wave generation circuit 8 through a demodulator 3, and is also connected with the parallel connection of a demodulator of transmitting part 7 and a detector circuit 9; outputs of the demodulator of transmitting part 7 and the detector circuit 9 are inputted to a control circuit of transmitting part 4; the control circuit of transmitting part 4 is connected to a memory circuit 5, and controls a modulator of transmitting part 3 and a variable reactance circuit 2 together with the input signal of the carrier wave generation circuit 1. The first receiver has a variable reactance circuit of receiving part 12, which is coupled to a receiving part antenna 11 and is connected in parallel with a demodulator of receiving part 17 and a modulator of receiving part 13. A rectifying circuit 16 is connected to the subsequent stage of the modulator 13, and supplies power to a control circuit of receiving part 14. The control circuit of receiving part 14 is connected to an ID memory device 15, and controls the modulator of receiving part 13 and the variable reactance circuit of receiving part 12 by using an output signal of the demodulator of receiving part 17. The configuration of the second receiver is also the same as that of the first receiver. The transmitter and the receivers are electromagnetically spatially coupled with one another, and the characteristics thereof can be represented in circuit by the mutual impedances rm1+JXm1 and rm2+JXm2. An electromagnetic equivalent circuit of FIG. 1 assumes the variable reactance circuits onward of the transmitter and the receivers as one high frequency circuit, and can make an equivalent circuit representation of FIG. 11B by using the characteristic impedances thereof: r+j0 and Ri+j0 (i=1, 2). The power transfer function in the equivalent circuit representation is given by Formula 1, and includes rmi, Xmi, X, and Xi as parameters. In other words, when the environment surrounding the transmitter and the receivers changes, rmi and Xmi change, and the power transmission from the transmitter to the receivers deteriorates, the effect of compensating the deterioration of the power transmission can be generated by changing X and Xi that are parameters within the equipment of the transmitter and the receivers. Further, if rmi and Xmi are defined, the power transmission from the transmitter to the receivers can be optimized by the adjustment of X and Xi. Although the relative position between the transmitter and the first receiver or the second receiver generally differs from each other, the transmitter can perform a deterioration compensating operation of the power transmission for the individual receivers by using a unique ID owned by each receiver.

Consequently, according to the present embodiment, there is the effect of achieving a highly efficient wireless power transmission between the transmitter and the plurality of receivers which are spatially separated from one another following the change of the ambient environment surrounding the transmitter and the receivers.

Further, since each receiver can discriminate a variety of control signals sent from the transmitter by the unique ID held by own equipment, unnecessary wireless signals from the other systems can be prevented from being erroneously recognized as control signals for own equipment, and this can create an effect of stabilizing the power transmission and improving the reliability thereof.

### Embodiment 2

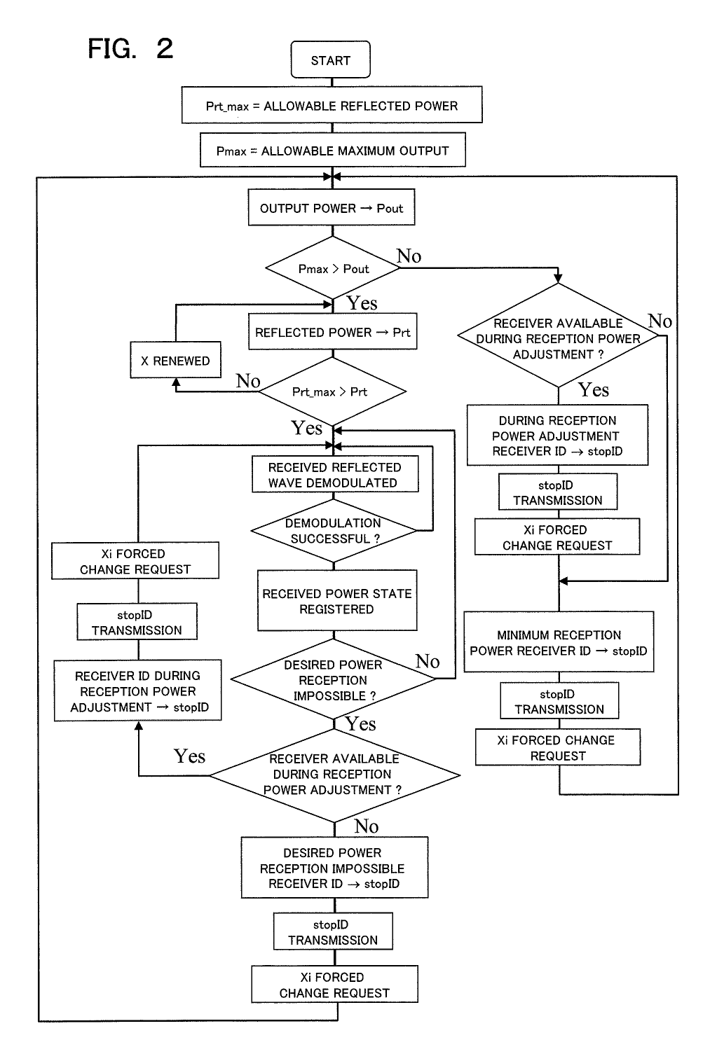

FIG. 2 is a flow chart showing the operation of a transmitter that is the component of the ID-controlled one-to-multiple wireless power transmission system of the present invention. Since the transmitter is unable to generate a limitless power, a maximum permissive output Pmax is defined in advance. The power generated from the carrier wave generation circuit 8 should be ideally all outputted to the external space by the transmitting part antenna 1. In practice, however, a part of the power is not outputted to the outside, but returned inside the transmitter. By reducing this return power, highly efficient power transmission efficiency from the transmitter to the receivers is achieved, and therefore, the maximum permissible value of this return power is defined as a permissible reflected power Prt_max in advance. To maintain the output of the carrier wave generation circuit 8 at a certain limit, a part of the output of the carrier wave generation circuit 8 is branched and monitored. When the output of the carrier wave generation circuit 8 exceeds Pmax because the number of receivers coupled with the transmitter is increased or the received power of the receivers is increased, first, a presence of the receiver trying to receive the power from the transmitter is retrieved from the receiver state transition table in the memory circuit 5 of the transmitter. If such receiver is present, a request for stopping the power reception is transmitted to the receiver together with the ID. If such a receiver is not present, the presence of a receiver receiving the power from the transmitter is retrieved from the receiver state transition table in the memory circuit 5 of the transmitter. When such a receiver is found, a request for stopping the power reception is transmitted to this receiver together with its ID.

Next, the transmitter monitors the power returned to the inside of the transmitter from the transmitting part antenna 1 by the directional coupler 6 and the detector circuit 9, and the control circuit of transmitting part 4 controls the variable reactance circuit of transmitting part 2 so that the return power becomes less than Prt_max. When such control is completed, the transmitter tries to receive signals from the receiver. When the demodulation of the signals entering inside the transmitter by the demodulator of transmitting part 7 through the directional coupler 6 of the transmitter is successful, an ID of the receiver, a state of the variable reactance circuit under a power reception state, and a received power value are written in the receiver state transition table inside the memory circuit 5. When the information on the “desired power reception not possible” is found in the received power state, to remove disturbance toward the receiver from the other receiver, the presence of a receiver trying to receive the power from the transmitter is retrieved from the receiver state transition table inside the memory circuit 5 of the transmitter, and if present, a request for stopping the power reception is transmitted to the receiver together with the ID. When such a receiver is not present, it is determined that the spatial positional relationship between the transmitter and the receiver and the like are essentially under the condition in which a sufficient power cannot be transmitted from the transmitter to the receiver, and a request for stopping the power reception is transmitted to the receiver together with the ID.

By repeating the above-described control, a highly efficient power transmission from the transmitter to the receiver can be stably realized without causing breakdown due to excessive power transmission by the transmitter.

### Embodiment 3

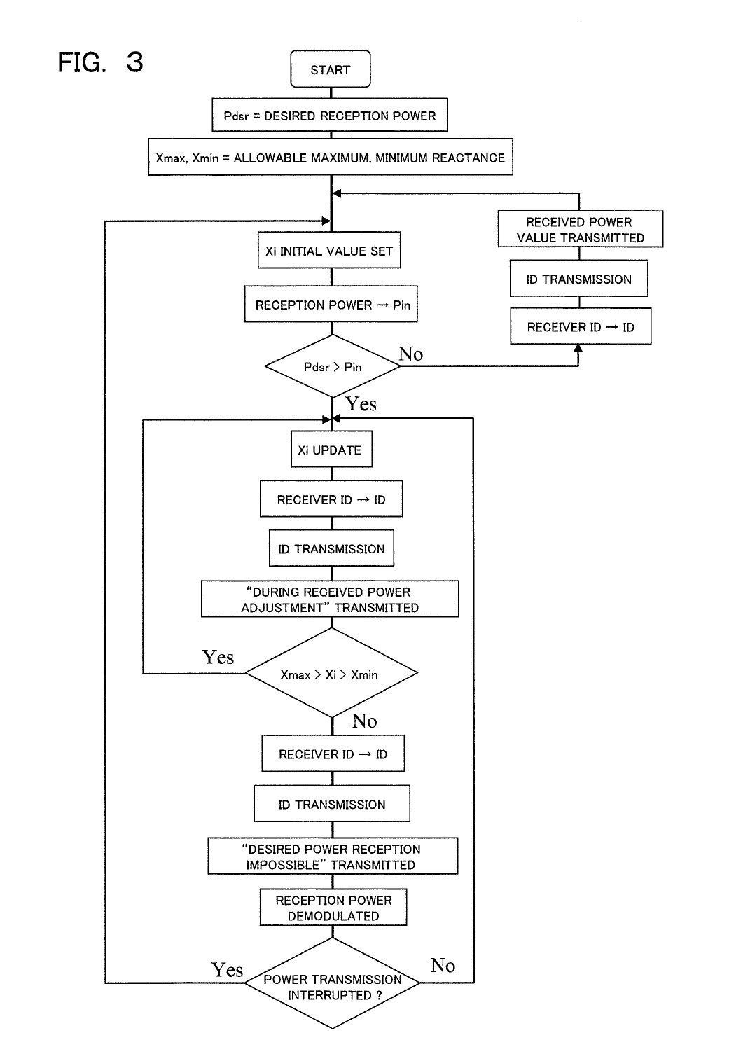

FIG. 3 is a flow chart showing the operation of a receiver that is the component of an ID-controlled one-to-multiple wireless power transmission system of the present invention. The receiver takes a required power reception amount as a desired received power Pdsr. In general, the receiver is required to be miniaturized, and for this reason, a scale of the variable reactance circuit of receiving part 12 cannot be enlarged, and a variable width of the reactance value is limited by Xmin and Xmax.

First, the receiver defines an initial reactance value of the variable reactance circuit of receiving part 12, and the received power at this time is obtained by monitoring the output of the rectifying circuit 16 with the control circuit of receiving part 14. When the received power reaches Pdsr as it is, the ID, the received power value, and information during power reception are transmitted to the transmitter.

If the received power does not reach Pdsr, a reactance value of the variable reactance circuit of receiving part 12 is changed, and control is started so as to make the received power approach to Pdsr, and the information on the “ID”, the “current received power value”, and the “under adjustment of received power” is transmitted to the transmitter. In the control process, when a requested reactance value of the variable reactance circuit of receiving part 12 deviates from a variable width Xmin to Xmax, the information on the “ID”, the “current received power value”, and the “desired power reception not possible” is transmitted to the transmitter in the anticipation of the improvement of the power transmission state on the transmitting side (stop of the power transmission to the other receivers, and the adjustment of a variable reactance circuit of transmitting part 2 on the transmitting side). Subsequently, signals from the transmitter are received, and are demodulated by a demodulator of receiving part 17, and when the control signal matching the receiver unique ID gets a command for stopping the power transmission from the transmitter, it is determined that a spatial positional relationship between the transmitter and the receiver and the like is essentially under the condition in which a sufficient power cannot be transmitted from the transmitter to the receiver, and the initial value of the variable reactance circuit of receiving part 12 is changed, and an attempt is made to connect to a transmitter separately from the transmitter with which the current communication has been performed.

By repeating the above-described control, the highly efficient power transmission of the one transmitter-to-multiple receiver can be achieved by flexibly responding to the power reception demands of the plurality of receivers.

### Embodiment 4

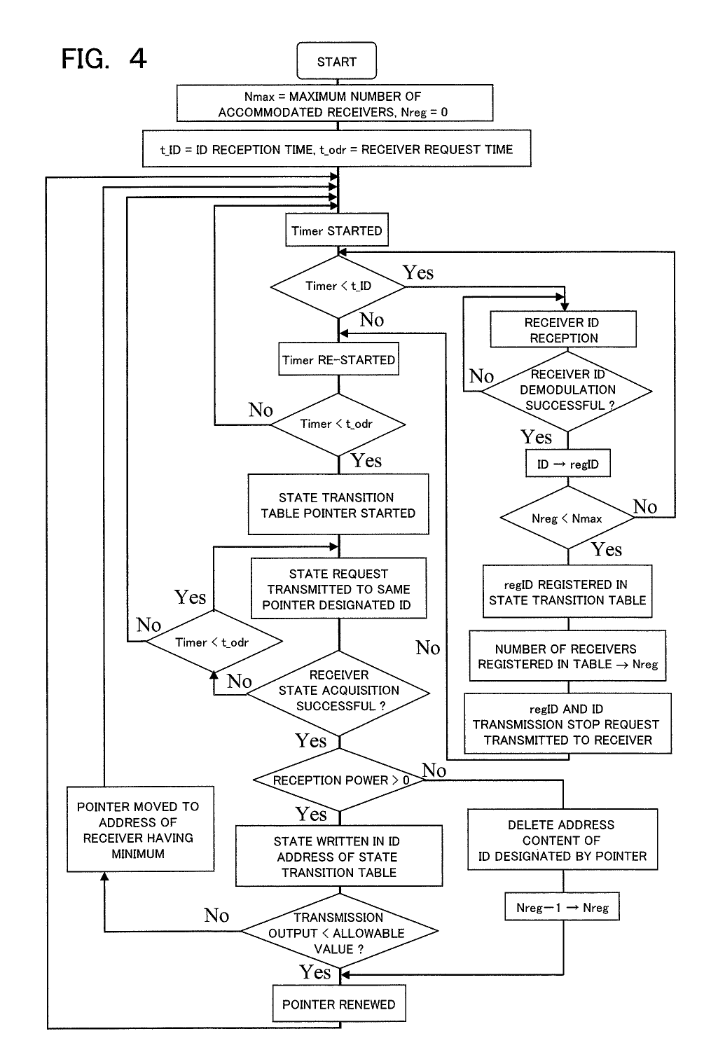

FIG. 4 is a flow chart showing an operation of a transmitter enabling grasp of a power reception state of each receiver required for controlling a plurality of receivers by a transmitter that is a component of an ID-controlled one-to-multiple wireless power transmission system of the present invention. Supposing an actual power transmission service, the transmitter is required to determine the number of receivers accommodatable in advance with respect to power transmission according to the condition such as the maximum transmission power, and this value is defined as Nmax in advance. It is apparent that Nmax is a common integer N being larger than or equal to 2. The transmitter is provided with a receiver state transition table for storing the information on the receivers, and resets the initial value thereof in advance with the total number of receivers registered at each time in the receiver state transition table as Nreg. The transmitter determines in advance an ID reception time t_ID, which is a time interval of receiving the unique ID of the receiver, and a receiver request time t_odr, which is a time interval of grasping the power reception states of the individual receivers in order to recognize the presence of a plurality of receivers. To manage the control by using these time intervals, the transmitter is provided with a Timer. First, the Timer is started, and an attempt is made to demodulate the reception signal from the receiver during the period of t_ID. When the demodulation is successful, it is confirmed whether or not the number of receivers registered in the receiver state transition table exceeds the maximum accommodatable number of receivers, and if not exceeding, the unique ID of the receiver included in the demodulation signal is written in the receiver state transition table, and the value of Nreg is increased by one and updated. It is confirmed whether or not the number of receivers registered in the receiver state transition table exceeds the maximum accommodatable number of receivers, and if exceeding, an attempt is made again to receive the unique ID of the receiver. When the demodulation is not successful, an attempt is made to repeat the demodulation during the period of t_ID. The receiver state transition table is provided with a receiver state transition table pointer. This pointer controls the reading order of the receiver state including the information on the ID of the receiver, the received power value of the receiver, and the operation associated with the power reception in the order of the address, which are written for each specific address by the receiver state transition table. When the period of t_ID expires, following the pointer showing the address of the receiver state transition table, a command to report the ID number written in the address shown by the pointer and the receiver state of the receiver equivalent to the ID are transmitted. After the transmission is terminated, to obtain a reply from the receiver, the signals from the receiver are received and demodulated; and when the demodulation is successful and a receiver state of the receiver is obtained, it is confirmed whether or not the received power of the receiver is zero; and when the received power is confirmed not to be zero, the receiver state is written subsequent to the unique ID of the receiver written in the address indicated by the current pointer. It is confirmed whether or not the received power of the receiver is zero, and when confirmed to be zero, since there is no need to hold the unique ID of the receiver and the receiver state of the receiver, the content of the address shown by the pointer is eliminated, and the value of Nreg is reduced by one and updated. When the demodulation is not successful, an attempt is made to repeat the demodulation during the period of t_odr. When the receiver state is obtained and the writing thereof in the receiver state transition table is terminated, the output power of the transmitter is confirmed. When the output power of the transmitter does not exceed an allowable value that is the maximum allowable output shown in the flow chart of FIG. 2, the address of the pointer is advanced, and the address is updated up to the point where the unique ID of the next receiver is written. If the output power of the transmitter exceeds the allowable value that is the maximum allowable output shown by the flow chart of FIG. 2, the receiver state transition table pointer is moved to the address where the ID corresponding to the receiver having the smallest received power out of each receiver written in the receiver state transition table is written. When these movements of the pointer are completed, the control returns back to the beginning to re-start the Timer, and repeats the above-described operation.

According to the present embodiment, since the transmission efficiency of the power to the plurality of receivers can be controlled by one transmitter, control can be made to maximize the power transmission efficiency of the entire system that performs the wireless power transmission through the one-to-multiple reactive energy.

### Embodiment 5

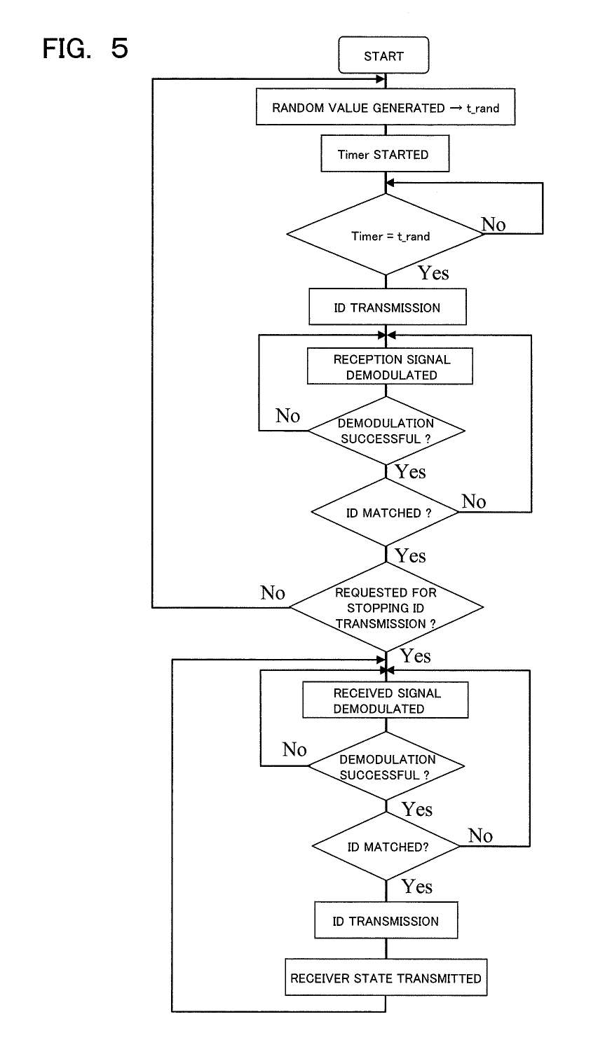

FIG. 5 is a flow chart showing an operation of a receiver enabling grasp of a power reception state of each receiver which is required for controlling a plurality of receivers by a transmitter that is a component of an ID-controlled one-to-multiple wireless power transmission system of the present invention. The receiver generates t_rand that is a random value being a time interval of transmitting a unique ID of each receiver in order to allow the transmitter to recognize presence of the ID. To manage the control by using this time interval, the receiver is provided with a Timer.

First, the Timer is started, and the unique ID of the receiver is transmitted at the time of t_rand. After that, the signal from the transmitter is received, and an attempt is made to demodulate the same. When the demodulation is successful, it is determined whether or not a unique ID of the receiver included in the modulation signal matches its own unique ID, and if matched, it is determined whether or not the signal received from the transmitter is a control command for itself, and a determination is made whether or not there is a request for stopping the ID transmission. When there is a request for stopping the ID transmission, a request is sent continuously at any timing to report on the receiver state including a control state on its received power amount and power reception; therefore, an attempt is made to demodulate the reception signal, and when the demodulation is successful, it is determined whether or not the ID included in the demodulated signal is the same as its own ID, and if the same, the receiver state is transmitted together with its own ID. When the demodulation fails or the ID included in the demodulated signal is different from its own ID, the demodulation is repeatedly performed anew. When the receiver stops the power reception itself under some conditions or interrupts power reception at the request from the transmitter, the receiver returns to the “start” of the flow chart of the present embodiment and the control is carried out again from the start.

According to the present embodiment, since the transmission efficiency of the power to the plurality of receivers can be controlled by one transmitter together as well as the embodiment of FIG. 4, a control can be made to maximize the power transmission efficiency of the entire system that performs the wireless power transmission through the one-to-multiple reactive energy.

### Embodiment 6

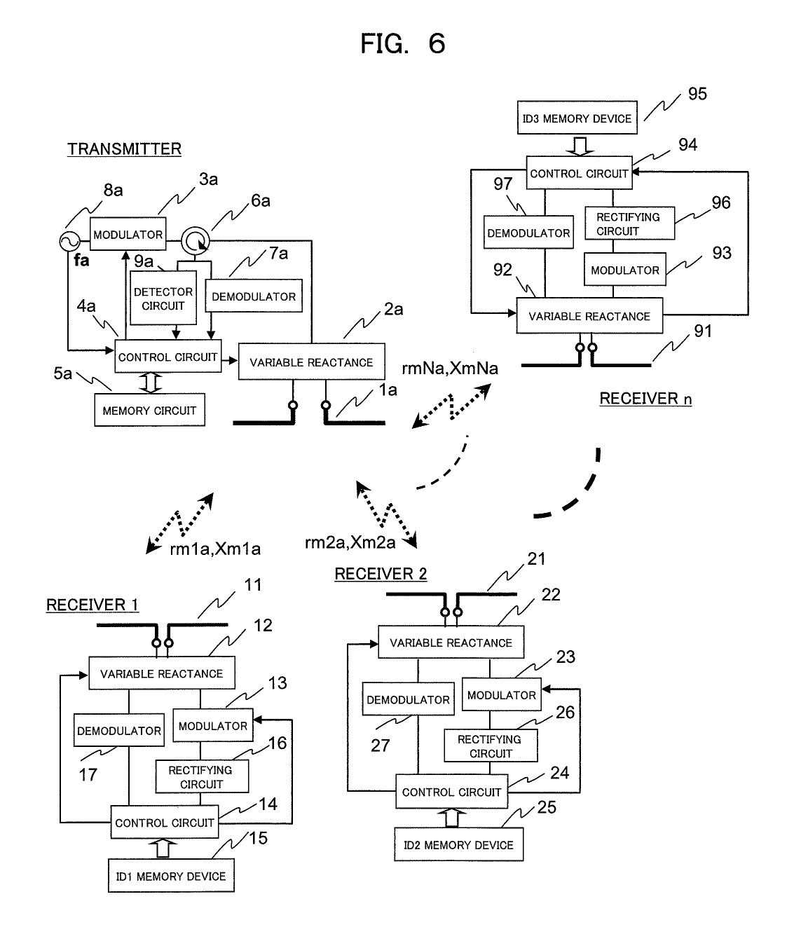

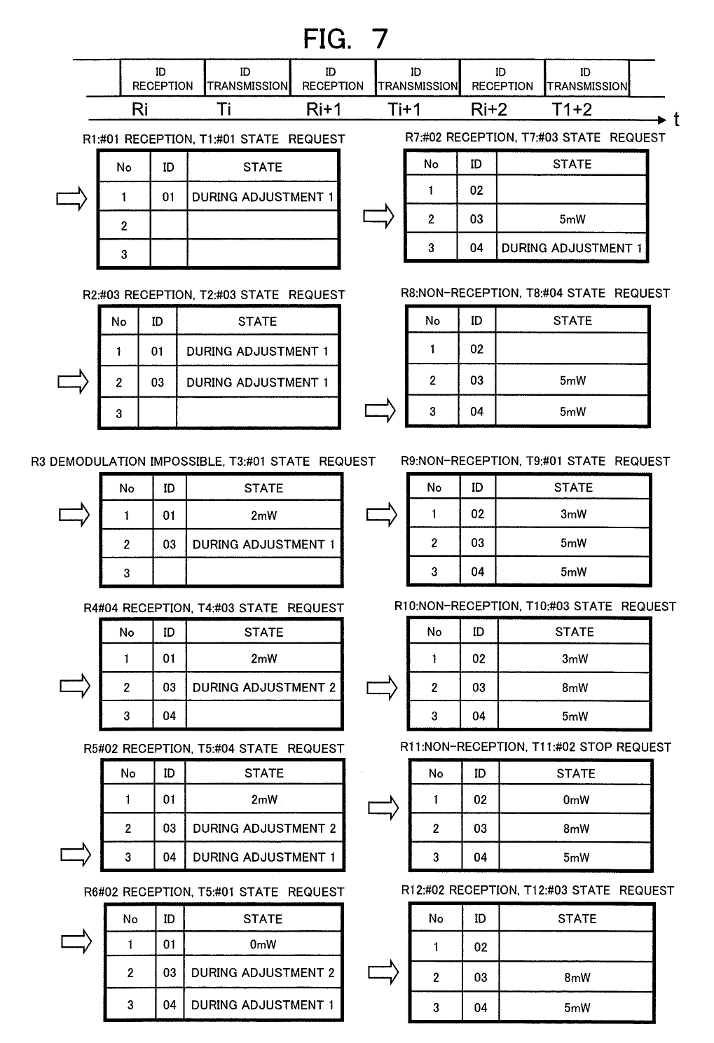

FIG. 6 is a view showing a structure of an embodiment in which one-to-multiple power transmission is performed by using the same frequency with one transmitter and N number of receivers (N≧2) in an ID-controlled one-to-multiple wireless power transmission system of the present invention, where the configuration of a transmitter 1 and a receiver 1 and a receiver 2 is the same as that of the embodiment of FIG. 1, and the configuration of a receiver 3 to the receiver N is the same as the configuration of the receiver 1. FIG. 7 is for giving explanations on the control method of the one-to-multiple power transmission of the ID-controlled one-to-multiple wireless power transmission system of the present invention by the specific configuration example of FIG. 6, and is a view to explain about the time sequence of the control of the transmitter and the receiver of the present invention by using an update state of the receiver state transition table inside a memory circuit 5 of the transmitter, a flow chart of the transmitter control, and the flow chart of the receiver control, respectively. In the present embodiment, the transmitter arranges a reception slot Ri for receiving an ID transmission signal from an unspecified receiver and a transmission slot Ti for transmitting a control signal to a specified receiver alternately on the time axis. Further, to make the explanation clear, the number of receivers used is four, and the transmitter is allowed to control up to three receivers at the same time. The maximum allowable output of the transmitter is set to 13 mW. By increasing the maximum allowable output of the transmitter, the number of receivers controllable simultaneously by the transmitter can be arbitrarily increased, and it is clear that the number of receivers existing around the transmitter is practically limitless.

At the slot R1, since the signal from the receiver of ID01 was able to be demodulated, ID01 is written in the receiver state transition table, and a command for stopping the ID transmission at specific timing of the receiver is transmitted together with ID01

At the slot T1, a request for report on the received power state is sent to the receiver of ID01, and the received power state from the receiver is written in the address corresponding to ID01 of the receiver state transition table.

At the slots R2 and T2, the same operation as the slots R1 and T1 was made for the receiver of ID03.

At the slot R3, the demodulation of signals failed probably because the transmission signals from a plurality of receivers came into collision with one another.

At the slot T3, since there is no registered receiver following ID01 and ID03, the same operation as the slot T1 was performed by returning to the start.

At the slot R4, since the signal from the receiver of ID04 was able to be demodulated, ID04 is written in the receiver state transition table, and a command for stopping the ID transmission at the specific timing of the receiver is transmitted together with ID04.

At the slot T4, a request for report on the received power state is sent to the receiver of ID 03, and the received power state from the receiver is written in the address equivalent to ID03 of the receiver state transition table.

At the slot R5, though the ID of the receiver of ID02 was received, no new control is made because the number of receivers controllable already reaches the maximum limit.

At the slot T5, the same operation as the slot T1 was performed for the receiver of ID04.

At the slot R6, no new control is performed similarly to the slot R5.

At the slot T6, since the received power being zero indicating the stop of power reception was obtained from the receiver of ID01, the address corresponding to ID01 was reset.

At the slots R7 and T7, the same operation as the slots R1 and T1 was performed for the receivers of ID02 and ID03.

At the slot R8, no reception signal was obtained.

At the slot T8, the same operation as the slot T1 was performed for the receiver of ID04.

At the slot R9, no reception signal was obtained.

At the slot T9, the same operation as the slot T1 was performed for the receiver of ID02.

At the slot R10, no reception signal was obtained.

At the slot T10, the same operation as the slot 11 was performed for the receiver of ID03. As a result, it turned out that the output of the transmitter exceeds the maximum allowable output. Hence, the receiver state transition table was searched for, and an ID transmission point was moved to the address for the ID (ID02) of the receiver having the smallest received power.

At the slot R11, no reception signal was obtained.

At the slot T11, a command for stopping the power reception was transmitted to the receiver of ID02. Since the received power being zero meaning the stop of the power reception was obtained from the receiver, the address corresponding to ID02 was reset.

At the slots R12 and T12, the same operation as the slots R1 and T1 was performed for the receivers of ID02 and ID03.

By the above-described control, the effect of achieving the efficient power transmission was obtained for the existing four receivers in response to the maximum controllable number of receivers of the transmitter, while suppressing the excessive output of the transmitter.

### Embodiment 7

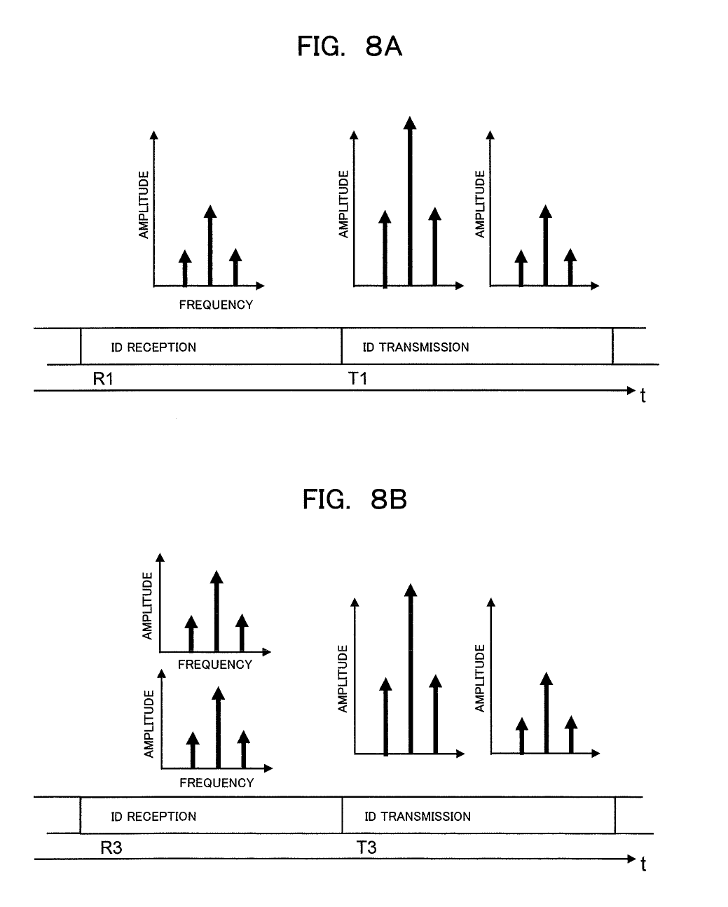

FIGS. 8A and 8B are views showing a frequency spectrum of the electromagnetic wave used by the power transmission system at each time slot of the ID-controlled one-to-multiple wireless power transmission system of FIG. 7. FIG. 8A shows a case of the slots R1 and T1, and FIG. 8B shows a case of the slots R3 and T3. From both of the drawings, it is found that the transmitter and the receiver use amplitude modulation such as back-scattering, and at the slot R1, since the signal from a single receiver arrives, the demodulation of the signal becomes possible, and at the slot R3, since the signals from two receivers arrive almost at the same time, the demodulation of those signals is not possible. In the ID-controlled one-to-multiple wireless power transmission system of the present invention, since the receiver transmits a unique ID of the receiver at the specific transmission timing, the signals carrying these IDs collided at the slot R3 are received respectively by the transmitter at any one of the reception slots Ri and demodulated.

### Embodiment 8

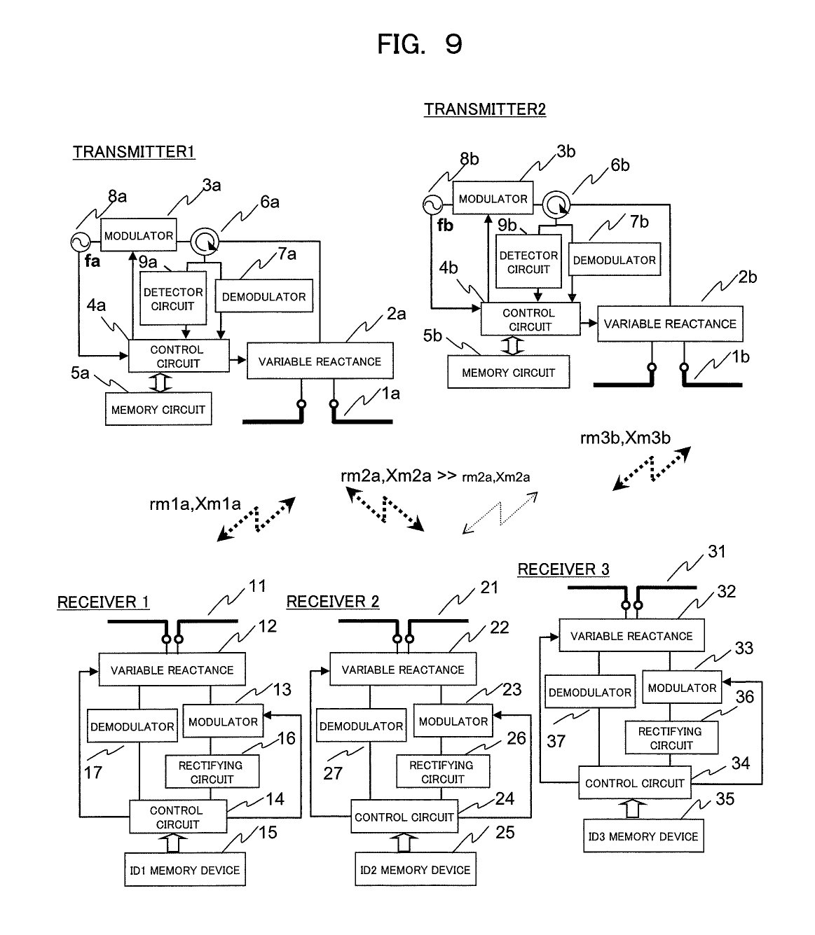

FIG. 9 is a view showing a structure of an embodiment in the case that two transmitters and three receivers different in frequency of carrier waves exist in an ID-controlled one-to-multiple wireless power transmission system of the present invention. The configurations of a transmitter 1 and a receiver 1 and a receiver 2 are the same as that of FIG. 1, and the configuration of the transmitter 2 and the configuration of a receiver 3 are the same as the configuration of the transmitter 1 and the configuration of the receiver 1, respectively. The operations of the transmitter and the receiver in the present embodiment are the same as those of the embodiments of FIGS. 2 to 4. In the present embodiment, although the receiver 2 can receive power from the transmitter 1 or a transmitter 2, since a mutual impedance amount with the transmitter 1 is larger than a mutual impedance amount with the transmitter 2, the power is supplied from the transmitter 1 according to the operations of the embodiments of FIGS. 2 to 4.

According to the present embodiment, since the number of receivers capable of transmitting the wireless power can be increased by using a plurality of frequencies, the present embodiment has the effect of increasing a power transmission capacity of the ID-controlled one-to-multiple wireless power transmission system of the present invention.

### Embodiment 9

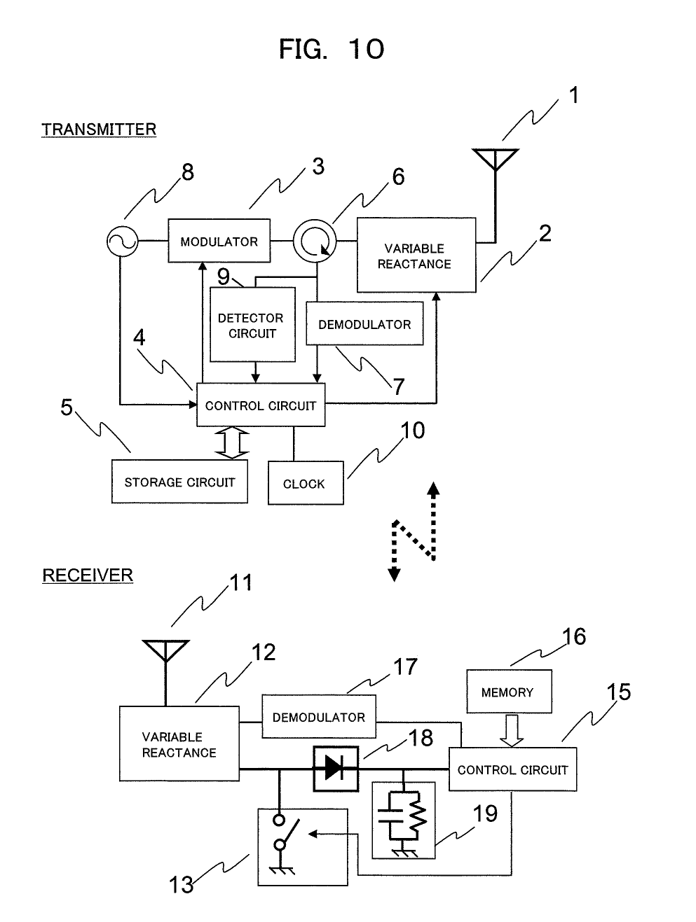

FIG. 10 is a view showing another embodiment of an ID-controlled one-to-multiple wireless power transmission system of the present invention. Different points from the embodiment of FIG. 1 are that the transmitter is provided with a clock 10 coupled with a control circuit 4, a demodulation circuit of receiving part 13 of the receiver is achieved by a semiconductor switch, and a receiving part rectifying circuit 14 is achieved by a diode 18 and a smoothing circuit 19. In the present embodiment, the transmitter can be provided with a receiver state history table inside a memory circuit 5. Since the power reception situation of the receiver can be stored in the receiver state history table with a time stamp, how much each receiver has used the power can be confirmed, and based on this information, it is possible to construct a charging system with respect to the power supplied to the receiver. When transmitting information to the transmitter, the receiver uses amplitude modulation as modulation means, which changes the impedance of the antenna of the receiver and changes the amplitude of electromagnetic energy reaching the transmitter.

This method is called a back-scattering method, and can transmit the information to the transmitter without generating a new carrier wave on the receiver side. This method can reduce power consumption with respect to the carrier wave generation, and therefore, the present embodiment has the effect of reducing power consumption of the receiver and also reducing the entire power consumption of the ID-controlled one-to-multiple wireless power transmission system.

### Embodiment 10

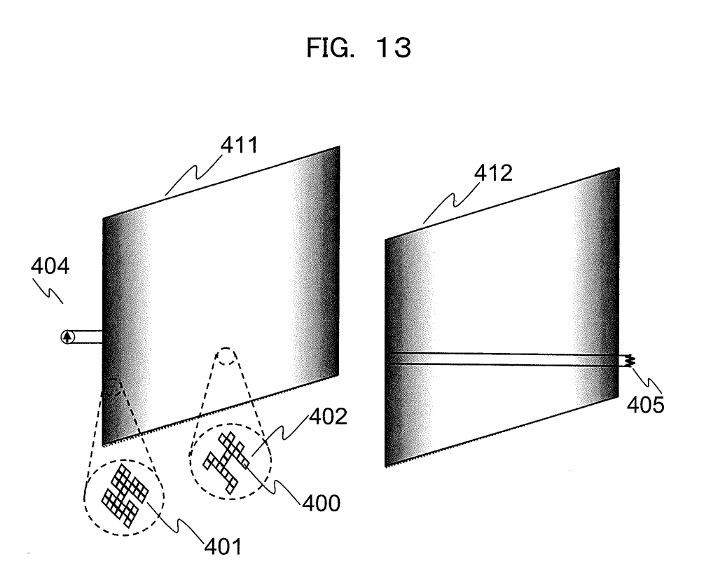

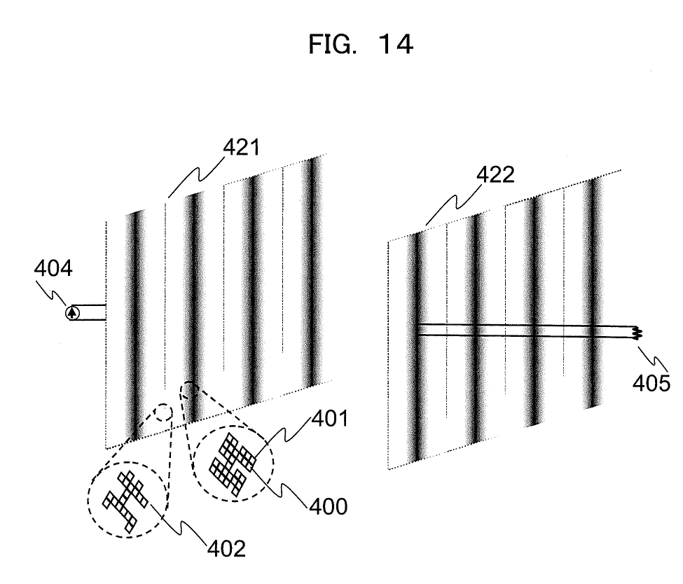

FIG. 13 is a view showing another embodiment of an ID-controlled one-to-multiple wireless power transmission system of the present invention, which is constituted of a transmitter antenna 411 and a receiver antenna 412 which are an assembly of minute conductors 400. A power supply point of the transmitter antenna 411 is coupled with an excitation current source 404, and the power supply point of the receiver antenna 412 is coupled with a load resistance 405. In the present embodiment, to explain about the structure for realizing the ID-controlled one-to-multiple wireless power transmission system, other components are omitted. The transmitter antenna 411 and the receiver antenna 412 have a plane-shape, and are formed symmetrically to one axis of symmetry on the plane, and the density of the minute conductors 400 is sparser in the vicinity of the axis of symmetry as represented by a non-dense pattern 402, and are arranged to become denser as represented by a dense pattern 401 when closer to a peripheral part. When power supply points of the transmitter antenna 411 and the receiver antenna 412 are provided so as to face each other so that these antenna mutually become an orthogonal projection of the other antenna shape and the common part of the antenna itself is maximized, these antennas are installed in such a manner that the distance between the power supply points is the shortest. Further, the power supply points of both the antennas are installed in a region where the density of the minute conductors is dense.

According to the present embodiment, since the distance between the power supply points of the transmitter antenna and the receiver antenna can be taken short, the mutual admittance can be taken large, and a sum of straight line distances from the minute conductors existing on the same antenna as seen from the power supply point can be taken large; thus, the real parts of the mutual admittances of the power supply points of the transmitter antenna and the receiver antenna can be made large, and the real parts of the self-admittances of both antennas can be made small; thus, the present embodiment has the effect of improving the power transmission efficiency of the ID-controlled one-to-multiple wireless power transmission system using the transmitter antenna and the receiver antenna of the present embodiment. Further, since many conductors can be installed in the vicinity of the power supply points of the transmitter antenna and the receiver antenna, the mechanical strength of the power supply points of both antennas can be increased, and the mechanical stability of a part on which the power is most concentrated out of the parts of the transmitter antenna and the receiver antenna can be improved; and the present embodiment has the effect of stabilizing the power transmission of the ID-controlled one-to-multiple wireless power transmission system as a result.

### Embodiment 11

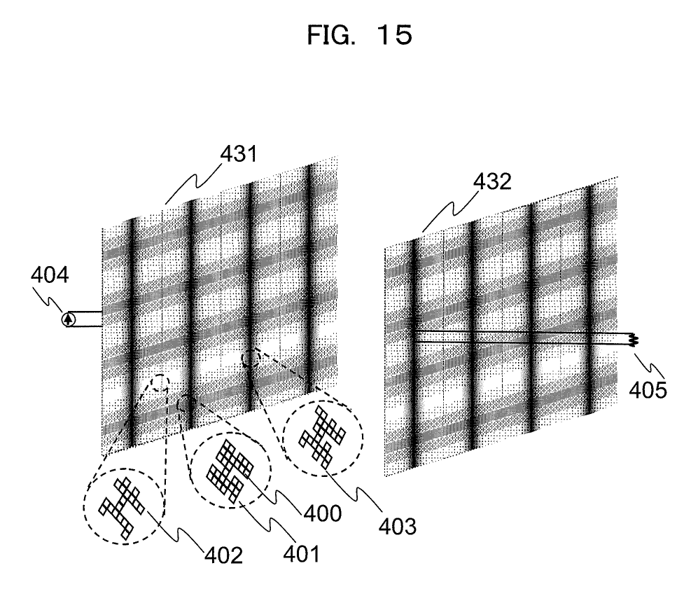

FIG. 14 is a view showing another embodiment of an ID-controlled one-to-multiple wireless power transmission system of the present invention. Different points from the embodiment of FIG. 13 are that a transmitter antenna 411 and a receiver antenna 412, which are an assembly of minute conductors 400 and have a plane structure, are formed symmetrically to one axis of symmetry on the plane, and a density of the minute conductors 400 repeats denseness and sparseness with periodicity.

According to the present embodiment, phases of electromagnetic waves generated by a plurality of minute conductors 400 that forms an antenna in a specific direction can be aligned. Consequently, in addition to the effect of the embodiment of FIG. 13, the strength of the electromagnetic wave in a specific direction vertical to the axis of symmetry can be increased, and thus, the present embodiment has the effect of improving the power transmission efficiency in the direction.

### Embodiment 12

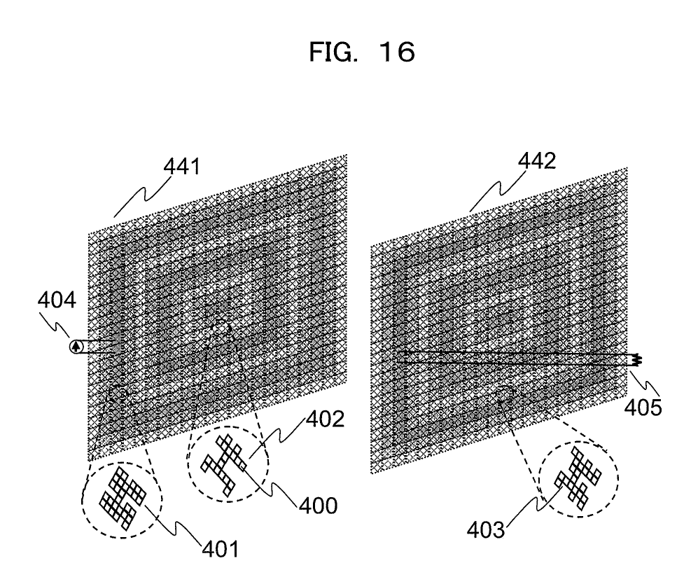

FIG. 15 is a view showing another embodiment of an ID-controlled one-to-multiple wireless power transmission system of the present invention. Different points from the embodiment of FIG. 13 are that a transmitter antenna 421 and a receiver antenna 422, which are an assembly of minute conductors 400 and have a plane structure, are formed symmetrically to two axes of symmetry mutually orthogonal on the plane, and a density of the minute conductors 400 repeats denseness and sparseness with periodicity. In the present embodiment, since two axes of symmetry that become a reference of periodicity exist, a medium density pattern 403 is shown, which is not shown in FIG. 14, in order to explain about two-dimensional dual periodicity.

According to the present embodiment, phases of electromagnetic waves generated by a plurality of minute conductors 400 that forms an antenna in a specific direction at a direction orthogonal to both of the two axes of symmetry orthogonal to each other can be aligned. Consequently, as compared with the embodiment of FIG. 14, the present embodiment has the effect of increasing the intensity of the electromagnetic waves in a specific direction.

### Embodiment 13

FIG. 16 is a view showing another embodiment of an ID-controlled one-to-multiple wireless power transmission system of the present invention. Different points from the embodiment of FIG. 13 are that a transmitter antenna 421 and a receiver antenna 422, which are an assembly of minute conductors 400 and have a plane structure, are formed with the normal direction of the plane as an axis of rotation, and a density of the minute conductors 400 repeats denseness and sparseness with periodicity with rotation symmetry in a moving radius direction vertical to the axis of rotation. In the present embodiment also, a medium density pattern 403 is shown, which is not shown in FIG. 14, in order to clarify the relationship between the antenna structure and the installation density of the minute conductors.

According to the present embodiment, by making the transmitter antenna and the receiver antenna face each other, the transmission efficiency of the power from the transmitter antenna to the receiver antenna can be improved as compared with the embodiment of FIG. 15.

### Embodiment 14

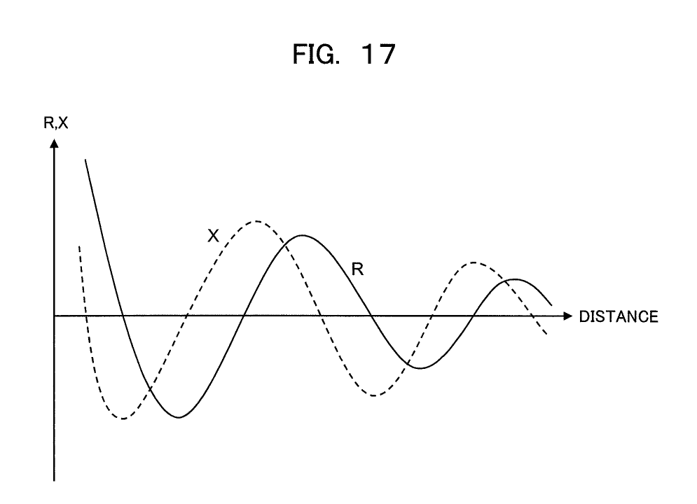

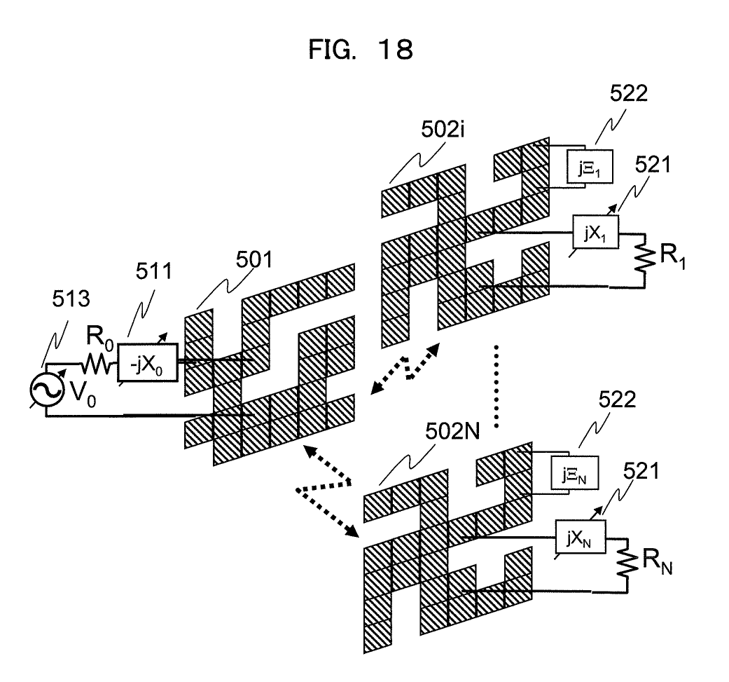

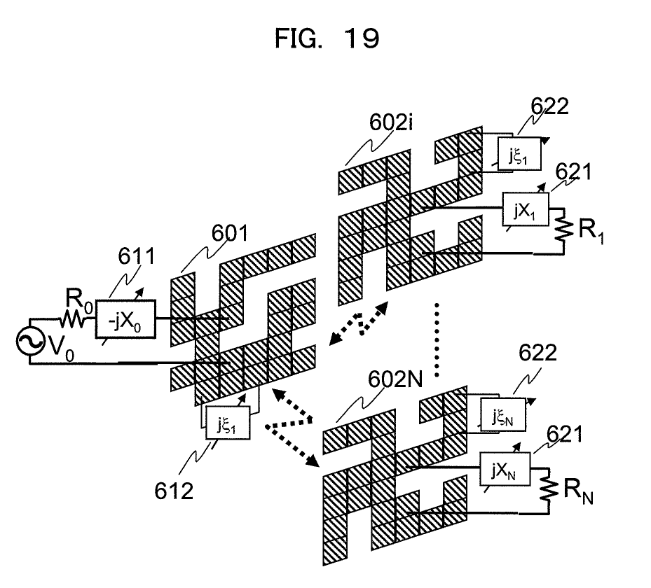

FIG. 18 is a view showing another embodiment of an ID-controlled one-to-multiple wireless power transmission system of the present invention. In the ID-controlled one-to-multiple wireless power transmission systems of the embodiments 1 to 13, a part of the structure of a receiver antenna is loaded with a distributed loading variable reactance element 522, and a transmitter is provided with a frequency-variable carrier wave generator 513. In FIG. 18, the system is constituted by one transmitter provided with a transmitter antenna 501 and a variable reactance element 511 and N number of receivers provided with a receiver antenna 502 and a variable reactance element 521, and the distributed loading reactance element 522. The mutual impedance between the transmitter antenna and the receiver antenna are designed such that the resonance condition in which the mutual reactance of FIG. 17 becomes zero is satisfied with respect to the relative position initially set between the transmitter antenna and the receiver antenna. To control the mutual impedance between the transmitter antenna and the receiver antenna in the case that the relative position between the transmitter and the receiver varies, the transmitter controls the carrier wave frequency of the transmitter so that the received power becomes the maximum by using the received power information from the receiver.

According to the present embodiment, since the mutual impedance between the transmitter antenna and the receiver antenna is adjusted so as to be closely related to the resonance condition in spite of the relative position between the transmitter and the receiver, the present embodiment has the effect of suppressing a decrease of the transmission efficiency of the power from the transmitter to the receiver with respect to the variation of the relative position between the transmitter and the receiver. In other words, the present example has the effect of mitigating restrictions on the alignment for the relative position between the transmitter and the receiver.

### Embodiment 15

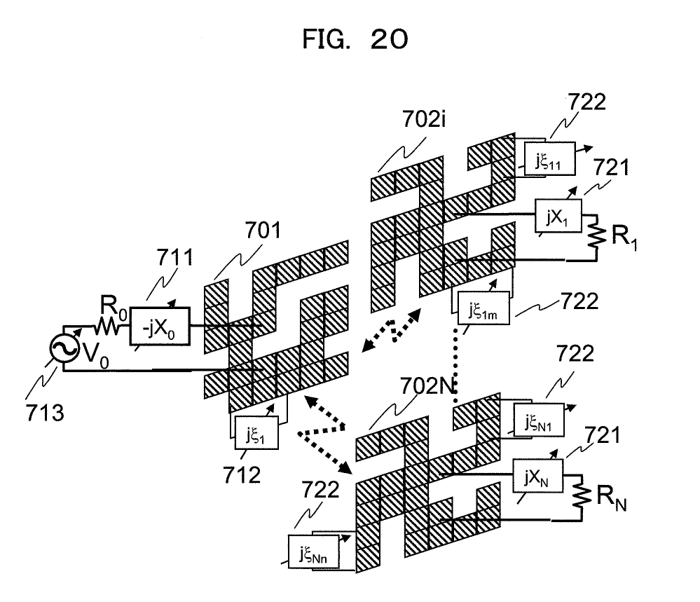

FIG. 19 is a view showing another embodiment of an ID-controlled one-to-multiple wireless power transmission system of the present invention. Different points from the ID-controlled one-to-multiple wireless power transmission system of FIG. 18 are that a part of the structure of a receiver antenna is joined with a distributed loading variable reactance element 622, and a part of the structure of a transmitter antenna is joined with a distributed loading variable reactance element 612. To control the mutual impedance between the transmitter antenna and the receiver antenna in the case that the relative position between a transmitter and a receiver is shifted, the transmitter controls the variable reactance elements of the transmitter and the receiver so as to maximize accepted power by using accepted power information from the receiver.

In the present embodiment also, since the mutual impedance between the transmitter antenna and the receiver antenna is adjusted so as to be closely related to resonance condition in spite of the relative position between the transmitter and the receiver, the present embodiment has the same effect as that of the embodiment 14.

### Embodiment 16

FIG. 20 is a view showing another embodiment of an ID-controlled one-to-multiple wireless power transmission system of the present invention. Different points from the ID-controlled one-to-multiple wireless power transmission system of FIG. 19 are that a part of the structure of a receiver antenna is coupled with a plurality of distributed loading variable reactance elements 721, and a transmitter is provided with a frequency variable carrier wave generator 713. To control the mutual impedance between the transmitter and the receiver in the case that the relative position between the transmitter and the receiver is shifted, the transmitter controls the carrier wave frequency of the transmitter and the variable reactance element of the transmitter and the receiver so that accepted power is maximized by using accepted power information from the receiver.

According to the present embodiment, since an application range of control for the mutual impedance between the transmitter antenna and the receiver antenna and the application range of the relative positional change width between the transmitter and the receiver can be enlarged, the present embodiment has the effect of mitigating restrictions on the alignment for the relative position between the transmitter and the receiver.

### Embodiment 17

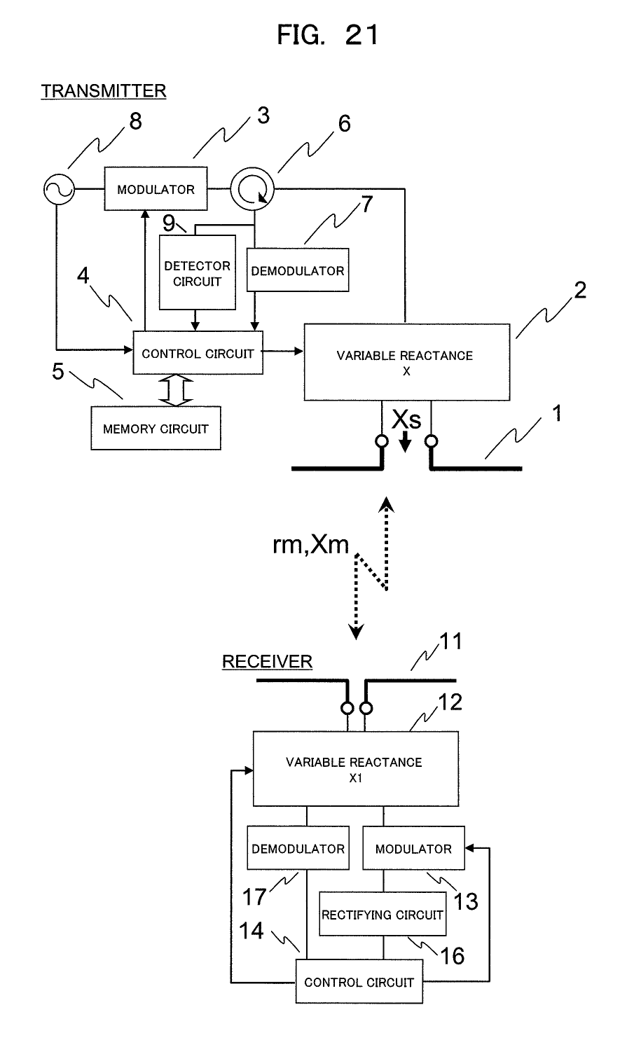

FIG. 21 is a view showing a configuration of an embodiment of an ID-controlled one-to-multiple wireless power transmission system of the present invention, which is constituted by one transmitter and one receiver. The transmitter has a variable reactance circuit of transmitting part 2 coupled to a transmitting part antenna 1, which is connected to a directional coupler 6. The directional coupler 6 is connected with a carrier wave generation circuit 8 through a modulator 3, and is also connected to a parallel connection of a demodulator of transmitting part 7 and a detector circuit 9. The outputs of the demodulator of transmitting part 7 and the detector circuit 9 are inputted to a control circuit of transmitting part 4. The transmitting control circuit 4 is connected to a memory circuit 5, and controls a modulator of transmitting part 3 and variable reactance circuit 2 together with input signals of the carrier wave generation circuit 8. A first receiver has a variable reactance circuit of receiving part 12 coupled to a receiving part antenna 11, and this variable reactance circuit of receiving part 12 is connected in parallel with a demodulator of receiving part 17 and a modulator of receiving part 13. The subsequent stage of the modulator 13 is connected with a rectifying circuit 16, and supplies power to a control circuit of receiving part 14. The receiving control circuit 14 controls the modulator of receiving part 13 and the variable reactance circuit of receiving part 12 by using the output signal of the demodulator of receiving part 17. The transmitter and the receiver are electromagnetically spatially coupled, and the characteristic thereof can be represented in circuit by the mutual impedances rm1+jXm1 and rm2+jXm2. The electromagnetic equivalent circuit of FIG. 1 can make an equivalent circuit expression such of FIG. 11B by taking components subsequent to the variable reactance circuits of the transmitter and the receiver as one high frequency circuit by using its characteristic impedances r+j0 and Ri+j0 (i=1, 2). The power transfer function in the equivalent circuit expression is given by the formula 1, and includes rmi, Xmi, X, and Xi as parameters. In other words, when the environment surrounding the transmitter and the receiver changes, rmi and Xmi change, and the power transmission from the transmitter to the receiver deteriorates, X and Xi that are parameters inside the equipment of the transmitter and the receiver are caused to change so that the effect of compensating the deterioration of the power transmission can be generated. Further, if rmi and Xmi are defined, the power transmission from the transmitter to the receiver can be optimized by the adjustment of X and Xi.

Consequently, according to the present embodiment, the effect can be obtained in which the highly efficient wireless power transmission can be realized between the transmitter and the receiver that are spatially apart from each other accompanied with the change of the ambient environment surrounding the transmitter and the receiver.

### DESCRIPTION OF THE REFERENCE NUMERALS

1 . . . TRANSMITTING PART ANTENNA, 2 . . . VARIABLE REACTANCE CIRCUIT OF TRANSMITTING PART, 3 . . . MODULATOR OF TRANSMITTING PART
4 . . . CONTROL CIRCUIT OF TRANSMITTING PART, 5 . . . MEMORY CIRCUIT, 6 . . . DIRECTIONAL COUPLER,
7 . . . DEMODULATOR OF TRANSMITTING PART, 8 . . . CARRIER WAVE GENERATION CIRCUIT, 9 . . . DETECTOR CIRCUIT, 10 . . . CLOCK
11 . . . RECEIVING PART ANTENNA, 12 . . . VARIABLE REACTANCE CIRCUIT OF RECEIVING PART, 13 . . . MODULATOR OF RECEIVING PART
14 . . . CONTROL CIRCUIT OF RECEIVING PART, 15 . . . ID MEMORY DEVICE, 16 . . . RECTIFYING CIRCUIT, 17 . . . DEMODULATOR OF RECEIVING PART
18 . . . DIODE, 19 . . . SMOOTHING CIRCUIT,
21 . . . RECEIVING PART ANTENNA, 22 . . . VARIABLE REACTANCE CIRCUIT OF RECEIVING PART, 23 . . . MODULATOR OF RECEIVING PART,
24 . . . CONTROL CIRCUIT OF RECEIVING PART, 25 . . . ID MEMORY DEVICE, 26 . . . RECTIFYING CIRCUIT, 27 . . . DEMODULATOR OF RECEIVING PART
31 . . . RECEIVING PART ANTENNA, 32 . . . VARIABLE REACTANCE CIRCUIT OF RECEIVING PART, 33 . . . MODULATOR OF RECEIVING PART,
34 . . . CONTROL CIRCUIT OF RECEIVING PART, 35 . . . ID MEMORY DEVICE, 36 . . . RECTIFYING CIRCUIT, 37 . . . DEMODULATOR OF RECEIVING PART,
41 . . . RECEIVING PART ANTENNA, 42 . . . VARIABLE REACTANCE CIRCUIT OF RECEIVING PART, 43 . . . MODULATOR OF RECEIVING PART,
44 . . . CONTROL CIRCUIT OF RECEIVING PART, 45 . . . ID MEMORY DEVICE, 46 . . . RECTIFYING CIRCUIT, 47 . . . DEMODULATOR OF RECEIVING PART,
100 . . . TRANSMITTING PART HIGH FREQUENCY CIRCUIT, 101 . . . TRANSMITTING PART ANTENNA,
102 . . . VARIABLE REACTANCE CIRCUIT OF TRANSMITTING PART, 108 . . . CARRIER WAVE GENERATION CIRCUIT,
200 . . . TRANSMITTINGT PART HIGMH FREQUENCY CIRCUIT, 201 . . . TRANSMITTING PART ANTENNA,
202 . . . VARIABLE REACTANCE CIRCUIT OF TRANSMITTING PART,
300 . . . MINUTE CONDUCTOR, 301 . . . TRANSMITTER ANTENNA,
302 . . . RECEIVER ANTENNA, 400 . . . MINUTE CONDUCTOR,
401 . . . SPARSE PATTERN, 402 . . . DENSE PATTERN,
403 . . . MEDIUM DENSE PATTERN, 404 . . . EXCITATION CURRENT SOURCE,
405 . . . LOAD RESISTANCE,
411 . . . TRANSMITTER ANTENNA, 412 . . . RECEIVER ANTENNA,
421 . . . TRANSMITTER ANTENNA, 422 . . . RECEIVER ANTENNA,
431 . . . TRANSMITTER ANTENNA, 432 . . . RECEIVER ANTENNA,
441 . . . TRANSMITTER ANTENNA, 442 . . . RECEIVER ANTENNA,
501 . . . TRANSMITTER ANTENNA, 502 . . . RECEIVER ANTENNA,
511 . . . VARIABLE REACTANCE ELEMENT, 513 . . . FREQUENCY VARIABLE CARRIER WAVE GENERATOR,
521 . . . VARIABLE REACTANCE ELEMENT, 522 . . . DISTRIBUTED LOADING VARIABLE REACTANCE ELEMENT,
601 . . . TRANSMITTER ANTENNA, 602 . . . RECEIVER ANTENNA
611 . . . VARIABLE REACTANCE ELEMENT, 612 . . . DISTRIBUTED LOADING VARIABLE REACTANCE ELEMENT,
621 . . . VARIABLE REACTANCE ELEMENT, 622 . . . DISTRIBUTED LOADING VARIABLE REACTANCE ELEMENT,
701 . . . TRANSMITTER ANTENNA, 702 . . . RECEIVER ANTENNA, 711 . . . VARIABLE REACTANCE ELEMENT,
712 . . . DISTRIBUTED LOADING VARIABLE REACTANCE ELEMENT, 713 . . . FREQUENCY VARIABLE CARRIER WAVE GENERATOR,
721 . . . VARIABLE REACTANCE ELEMENT, and 722 . . . DISTRIBUTED LOADING VARIABLE REACTANCE ELEMENT.

1. A wireless power transmission system comprising one transmitter and a plurality of receivers,
wherein the transmitter includes an antenna, a variable reactance circuit of transmitting part, a control circuit of transmitting part, a modulator of transmitting part, and a carrier wave generation circuit;
each of the receivers includes an antenna, a variable reactance circuit of receiving part, a demodulator of receiving part, a control circuit of receiving part, a rectifying circuit, and an ID memory device;
an ID unique to each one of the receivers is applied to each of the receivers;
the transmitter controls the variable reactance circuit of transmitting part by the control circuit of transmitting part, and transmits the ID and a control command; and
each of the receivers receives the ID and the control command transmitted from the transmitter, and the receiver having its received ID matches an ID unique to the receiver stored in the ID memory device controls the variable reactance circuit of receiving part by the control circuit of receiving part.

2. The wireless power transmission system according to claim 1,
wherein control of the variable reactance circuit of transmitting part of the transmitter, and control of the variable reactance circuit of receiving part of a single or a plurality of receivers are alternately performed in a chronologic order.

3. The wireless power transmission system according to claim 2,
wherein the transmitter further includes a directional coupler and a detector circuit, and, out of the outputs of the carrier wave generation circuit, power reflected by the antenna of the transmitter and not outputted to the outside of the transmitter but returned to the inside of the transmitter is detected, and the variable reactance circuit of transmitting part is adjusted by the control circuit of transmitting part so that the returned power is minimum; and
each of the receivers adjusts the variable reactance circuit of transmitting part by the control circuit of receiving part so that the power obtained by the rectifying circuit is the maximum.

4. The wireless power transmission system according to claim 3,
wherein the transmitter further comprises a demodulator of transmitting part and a memory circuit;
each of the receivers further comprises a demodulator of receiving part;
each of the receivers transmits a control state of a variable reactance circuit, received power, and a unique ID stored in an ID memory device in advance to the transmitter by using the demodulator of receiving part; and
the transmitter reads a transmitted content of the receiver by the demodulator of transmitting part, and writes a receiver ID, the control state of the variable reactance circuit, and the received power in a receiver state transition table existing inside the memory circuit.

5. The wireless power transmission system according to claim 4,
wherein the transmitter updates a result of reading a content of the receiver state transition table and the transmitted content of the receiver for each of the receiver IDs.

6. The wireless power transmission system according to claim 5,
wherein the transmitter has a maximum allowable output power value, and,
when a transmission output exceeds the maximum allowable output power value, a signal for requesting stop of power reception is transmitted together with a unique ID of the receiver to any one of a single or a plurality of receivers performing exchanges of information, and out of the receivers having received the signal, the receivers having matching unique IDs perform a stopping operation of the power reception by the control circuit of receiving part.

7. The wireless power transmission system according to claim 6,
wherein the receiver stopping reception of power is sequentially selected from the receivers corresponding to IDs of smaller received power written in the receiver state transition table inside the memory circuit of the transmitter.

8. The wireless power transmission system according to claim 7,
wherein the control state of the variable reactance circuit written in the receiver state transition table inside the memory circuit of the transmitter is sequentially selected from the receiver corresponding to the ID which has not yet reached a stable state in the power reception during the control.

9. The wireless power transmission system according to claim 8,
wherein the transmitter has a first time slot for transmitting a control command to the receiver at a fixed time interval;
a control signal is transmitted to the receiver together with the ID sequentially for each ID written in the receiver state transition table at the first time slot; and
the receiver receives the control signal, and when the ID included in the received signal matches its own ID, the receiver transmits a control state of the variable reactance circuit, received power, and a unique ID stored in the ID memory device in advance to the transmitter by using the modulator of receiving part.

10. The wireless power transmission system according to claim 9,
wherein, when output power of the transmitter exceeds a preset maximum allowable output power value, a receiver control signal is transmitted with giving priority to the ID of the receiver smaller in received power written in the receiver state transition table.

11. The wireless power transmission system according to claim 10,
wherein, when the output power of the transmitter exceeds the preset maximum allowable output power value, the receiver control signal is transmitted with giving priority to the ID with a control state of the variable reactance circuit written in the receiver state transition table being under control and the power reception which has not yet reached a stable state.

12. The wireless power transmission system according to claim 11,
wherein, when the receiver stops the power reception and the received power is zero across the plurality of first time slots because of a control state of the variable reactance circuit equivalent to the receiver of the unique ID received by the transmitter and the received power, the transmitter deletes the ID and the control state of the variable reactance circuit and also the received power written in the receiver state transition table inside the store circuit.

13. The wireless power transmission system according to claim 12,
wherein the transmitter further includes a receiver state history table and a clock inside the memory circuit; and,
when the ID, the control state of the variable reactance circuit, and the received power written in the receiver state transition table inside the memory circuit are deleted, contents and time of the deletion are sequentially stored in the receiver state history table.

14. The wireless power transmission system according to claim 13,
wherein the transmitter has a second time slot being different from the first time slot;
the receiver transmits its own ID at a specific transmission interval;
the transmitter receives an ID signal from the receiver at the second time slot, and writes the ID signal in the receiver state transition table inside the memory circuit, and transmits a signal for stopping the transmission of its own ID having a transmission interval unique to the receiver from the receiver together with the ID; and
the receiver receives the signal for stopping the transmission of its own ID having a specific transmission interval, and when the ID included in the reception signal matches its own unique ID, the receiver stops the transmission of its own ID having the unique transmission interval.

15. The wireless power transmission system according to claim 14,
wherein a receiver having stopped power reception by a command from the transmitter transmits its own ID anew at a unique transmission interval, and re-starts the operation of the power reception.

16. The wireless power transmission system according to claim 15,
wherein the first time slot and the second time slot are alternately set on a time axis.

17. The wireless power transmission system according to claim 16,
wherein the transmitter includes a plurality of transmitters provided with carrier wave generators different in frequency; and
the receiver includes a plurality of receivers provided with carrier wave generators different in frequency.

18. The wireless power transmission system according to claim 17,
wherein charging is performed according to power supplied by using the information stored in the receiver state transition table.

19. A wireless power transmission apparatus comprising one transmitter and a plurality of receivers,
wherein the transmitter includes an antenna, a variable reactance circuit of transmitting part, a control circuit of transmitting part, a modulator of transmitting part, and a carrier wave generation circuit;
each of the receivers includes an antenna, a variable reactance circuit of receiving part, a demodulator of receiving part, a control circuit of receiving part, a rectifying circuit, and an ID memory device;
an ID unique to each one of the receivers is applied to each of the receivers;
the transmitter controls the variable reactance circuit of transmitting part by the control circuit of transmitting part, and transmits the ID and a control command;
each of the receivers receives the ID and the control command transmitted from the transmitter, and the receiver having its received ID matches an ID unique to the receiver stored in the ID memory device controls the variable reactance circuit of receiving part by the control circuit of receiving part,
the wireless power transmission apparatus further comprising a modulator circuit together with the antenna, the variable reactance circuit of receiving part, the demodulator of receiving part, the control circuit of receiving part, the rectifying circuit, and the ID memory device,
the modulator circuit including a semiconductor switch and performing communication to the transmitter by a back-scattering method.

20. The wireless power transmission apparatus according to claim 19,
wherein, as compared with characteristic impedances of the electronic circuits of the transmitter and the receiver, a real part of the self-impedance of the antenna of the transmitter and a real part of the self-impedance of the antenna of the receiver are smaller than real parts of the mutual impedances of the antenna of the transmitter and the antenna of the receiver, respectively.

21. The wireless power transmission apparatus according to claim 20,
wherein the antennas of the transmitter and the receiver are formed by an assembly of a plurality of minute polygonal conductors on a flat surface, and the plurality of minute polygonal conductors are arranged so that the density is symmetrical to an axis of symmetry possessed by the flat surface, and each of power supply points provided on the minute polygonal conductors existing on the antenna of the transmitter and on the antenna of the receiver forms the shortest distance to connect the antenna of the transmitter and the antenna of the receiver, and is distributed apart from the axis of symmetry.

22. The wireless power transmission apparatus according to claim 21,
wherein the antennas of the transmitter and the receiver are achieved on one flat surface.

23. The wireless power transmission apparatus according to claim 22,
wherein the plurality of minute polygonal conductors forming the antennas of the transmitter and the receiver are rectangle-shaped.

24. The wireless power transmission apparatus according to claim 22,
wherein the plurality of minute polygonal conductors forming the antennas of the transmitter and the receiver are triangle-shaped.

25. The wireless power transmission apparatus according to claim 19,
wherein a mutual impedance of an antenna system formed by the antennas of the transmitter and the receiver satisfies the resonance condition.

26. The wireless power transmission apparatus according to claim 25,
wherein a reactance element is loaded on a part of the structure of the antenna of the receiver; and
the reactance element follows a relative positional change of the antennas of the transmitter and the receiver, and changes a frequency of an electromagnetic wave transmitted by the transmitter in order to maintain the resonance condition.

27. The wireless power transmission apparatus according to claim 26,
wherein a part of the structures of the antenna of the transmitter and the antenna of the receiver is loaded with a variable reactance element; and
the variable reactance element follows the relative positional change of the antennas of the transmitter and the receiver, and is controlled by the transmitter in order to maintain the resonance condition.

28. The wireless power transmission apparatus according to claim 27,
wherein the variable reactance element is controlled by the transmitter by changing the frequency of the electromagnetic wave transmitted by the transmitter.
